(19) United States
(12) Patent Application Publication
(10) Pub. No.: US 2012/0068846 A1
(43) Pub. Date: Mar. 22, 2012

(54) TAMPER EVENT DETECTION

(75) Inventors: William J. Dalzell, Parrish, FL (US); Scott G. Fleischman, Palmetto, FL (US); James L. Tucker, Clearwater, FL (US)

(73) Assignee: HONEYWELL INTERNATIONAL INC., Morristown, NJ (US)

(21) Appl. No.: 12/885,961

(22) Filed: Sep. 20, 2010

(51) Int. Cl. G08B 13/08; B65D 43/16; B23P 19/04; E06B 3/38

(52) U.S. Cl. 340/545.1; 49/506; 220/810; 29/428

(57) ABSTRACT

A tamper-indicating assembly includes a container formed by a plurality of walls and a door mechanically coupled to at least one of the walls via a hinge. At least one cable extends at least partially through the hinge between the door and the at least one wall. The cable transmits a signal, and the assembly can identify potential tamper events related to opening and closing of the door based on changes in properties of the transmitted signal. Techniques for forming the assembly are also described.

### TECHNICAL FIELD

The disclosure relates to tamper event detection.

### BACKGROUND

In some applications, sensitive, high-value equipment, such as weapons or electronic components, may be transported in containers. The containers may be highly reliable in order to protect the equipment and prevent unauthorized examination, manipulation or use of the equipment.

### SUMMARY

The disclosure is directed to a devices, systems, and methods for identifying a tamper event. In some examples, an assembly includes a container formed by a plurality of walls and a door. The assembly also includes a hinge that mechanically couples the door to at least one of the walls of the container and at least one cable that extends through the hinge. Due to the positioning of the cable within the hinge, a characteristic of a signal that is transmitted via the cable may correlate to rotation of the hinge. In this way, the signal that is transmitted via the cable may help detect opening of the container door and, therefore, possible tamper events, e.g., tampering of an article enclosed within the container. The disclosure is also directed to techniques for forming an assembly that includes a plurality of walls, a door, a hinge, and a cable that extends through the hinge. In addition, the disclosure is directed to techniques for detecting a tamper event using the assembly described herein.

In one aspect, the disclosure is directed to a tamper-indicating assembly that includes a plurality of walls, a door, at least one hinge that mechanically couples the door to at least one wall of the plurality of walls, and at least one cable extending at least partially through the hinge between the door and the at least one wall. The plurality of walls and the door define a cavity.

In another aspect, the disclosure is directed to a method that includes mechanically coupling a door to at least one wall of a plurality of walls via at least one hinge and positioning at least one cable such that the at least one cable extends at least partially through the hinge between the door and the at least one wall. The plurality of walls and the door define a cavity.

In another aspect, the disclosure is directed to an article of manufacture comprising a computer-readable storage medium. The computer-readable storage medium comprises computer-readable instructions for execution by a processor. The instructions cause a programmable processor to perform any part of the techniques described herein. The instructions may be, for example, software instructions, such as those used to define a software or computer program. The computer-readable medium may be a computer-readable storage medium such as a storage device (e.g., a disk drive, or an optical drive), memory (e.g., a Flash memory, read only memory (ROM), or random access memory (RAM)) or any other type of volatile or non-volatile memory that stores instructions (e.g., in the form of a computer program or other executable) to cause a programmable processor to perform the techniques described herein. The computer-readable medium may be nontransitory.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a schematic perspective view of an assembly that includes a plurality of walls, a door, a hinge, and a cable extending through the hinge.

FIG. 2 is a schematic side view of an example configuration of a tamper-indicating system that includes a cable extending through a hinge along the axis of rotation of the hinge.

FIG. 3 is a schematic cross-section view of the tamper-indicating system illustrated in FIG. 3.

FIG. 4 is a schematic side view of another example configuration of a tamper-indicating system that includes a cable extending at least partially through a hinge along an axis separate from, but substantially parallel to, the axis of rotation of the hinge.

FIG. 5 is a schematic side view of the tamper-indicating system illustrated in FIG. 4.

FIGS. 6A and 6B are schematic cross-sectional top views of the tamper-indicating system illustrated in FIGS. 4 and 5. The cross-section illustrated in FIGS. 6A and 6B is taken along line A-A shown in FIG. 4.

FIG. 7 is a schematic side view of another example configuration of a tamper-indicating system that includes a cable extending through a hinge, whereby the cable is wound around in a spool configuration within the hinge.

FIG. 8 is a schematic perspective view of the tamper-indicating system illustrated in FIG. 7.

FIG. 9 is a schematic top view of the tamper-indicating system illustrated in FIGS. 7 and 8.

FIG. 10 is a schematic cross-sectional view of a portion of the tamper-indicating system illustrated in FIGS. 7-9.

FIG. 11 is a flow diagram illustrating an example technique for forming a tamper-indicating assembly that includes a plurality of walls, a door, a hinge, and a cable extending through the hinge.

FIG. 12 is a functional block diagram illustrating a sensor and other components of a tamper-indicating assembly that can detect a possible tamper event.

FIG. 13 is a flow diagram illustrating an example technique for identifying a possible tamper event with a tamper-indicating assembly.

### DETAILED DESCRIPTION

In some applications, a sensitive, high-value article, such as a weapon or electronic equipment, is stored in a container. Because the article may contain sensitive information and/or may be very expensive, the container can be configured to detect tampering with the container, which may indicate the article has been tampered with, and/or protect the article from tampering, e.g., unauthorized examination, manipulation or use. For example, in some examples, the container may include a tamper-indicating system that performs a defensive action to protect the stored article if a tamper event is suspected.

In some examples, the storage container for the article can be formed from a plurality of walls and a door that is mechanically coupled to at least one of the walls, where the plurality of walls and door define a cavity configured to receive the article. In some conventional configurations, a tamper-indicating system may include a sensor system that can detect tampering with one of the wall surfaces, such as drilling into one of the walls. In some of these examples, a sensor system separate from that used for the wall surface may be used to detect tampering with the door surface of the container. The existing sensing systems that are constrained to the door do not detect motion of the door. In contrast, the tamper-indicating systems described herein include a common sensor system that detects tampering with both a door and a wall of a container, as well as opening of the door.

The sensor systems described herein include a hinge that mechanically couples the door to at least one of the walls of the container, and a cable that extends through the hinge. The cable can be used to detect rotation of the hinge and, consequently, to detect possible tamper events, e.g., unauthorized opening of the container door. In comparison to conventional configurations, the tamper-indicating systems described herein can increase the likelihood that a tamper event may be detected because the systems can detect rotation of the hinge, which may correlate to opening of the door of the container, in addition to detecting tampering with one of the walls or the door surface of the container. Additionally, the systems may reduce the cost of a tamper-indicating system by eliminating the need for separate sensor systems to detect tampering with the walls and door of the container. Moreover, the systems described herein may weigh less and require fewer parts because one cable can continuously extend through the hinge and through substantially the entire container, e.g., through one or more of the walls and the door surface of the container.

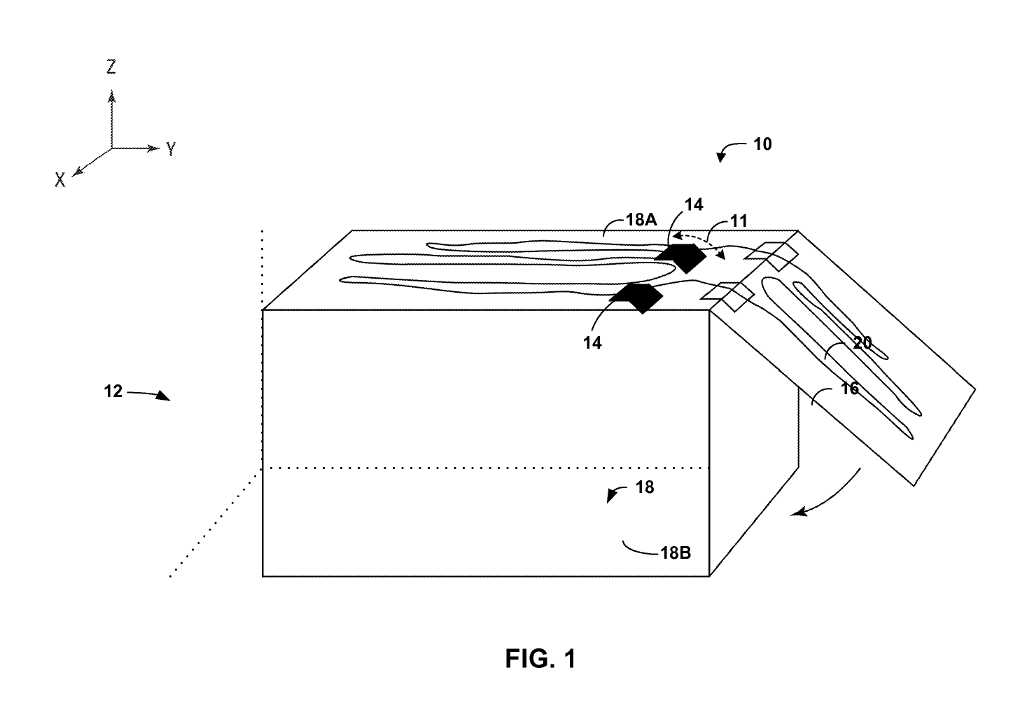

FIG. 1 illustrates assembly 10, which includes container 12, hinges 14, and cable 16. In the example illustrated in FIG. 1, container 12 includes door 20 and five walls 18 (only two of which are visible in FIG. 1), including top wall 18A and bottom wall 18B that is substantially opposite top wall 18A. In the examples illustrated herein, door 20 is mechanically coupled to top wall 18A via hinges 14. Container 12 defines a cavity into which one or more articles can be placed and stored.

Container 12 can be configured in any manner suitable for defining a cavity into which one or more articles can be placed. For example, in the example shown in FIG. 1, five walls 18 and one door 20 define the cavity that is configured to receive one or more articles. In other examples, container 12 can include any suitable number of walls and any suitable number of doors such that container 12 defines a housing for the article stored within container 12. In the example illustrated in FIG. 1, container 12 defines a cavity having a substantially rectangular cross-section (in the x-z, y-z, and x-y planes, where orthogonal x-y-z axes are shown in FIG. 1 for ease of description only). In other examples, container 12 may define a cavity (or compartment) of a different cross-sectional shape, e.g., a square, oval or circle.

Container 12 can minimize exposure of the articles stored within container 12 to external factors, such as moisture, contaminants, or other environmental contaminants, mechanical forces, and the like, which may adversely affect the articles stored within container 12. For example, container 12 may be formed from a particular material that can protect the articles. In some examples, container 12 can be formed from substantially rigid materials, such as rigid plastics, metals, or wood that can protect the articles housed within container 12 from some external factors such as relatively large mechanical forces.

In the example illustrated in FIG. 1, door 20 defines substantially one side of container 12. That is, container 12 defines a substantially rectangular shape, and door 20 defines substantially an entire side of container 12. In other examples, door 20 may be configured such that door 20 does not define an entire side of container 12. For example, one or more of walls 18 may define a space, e.g., a cutout, into which door 20 can be positioned such that door 20 occupies the space within a portion of one or more of walls 18. That is, door 20 may be positioned within the same plane as one or more of walls 18 and may occupy space defined by only a portion of one or more surfaces of container 12.

Door 20 is mechanically coupled to one or more walls 18 via one or more hinges 14. In the examples described herein, hinges 14 mechanically couple door 20 to top wall 18A, which is defined as wall 18 with the greatest z-axis position. In other examples, door 20 may be mechanically coupled to another one or more of walls 18 instead of or in addition to wall 18A. In the examples described herein, hinges 14 allow door 20 to rotate around an axis defined along the intersection of door 20 and top wall 18A in order to open and close. As illustrated in FIG. 1, the axis around which door 20 and hinges 14 rotate extends in the x-axis direction. Hereinafter, the axis around which door 20 and hinges 14 rotate may be referred to as the axis of rotation of hinges 14.

Hinges 14 are configured to allow door 20 to rotate relative to wall 18A about a fixed axis of rotation. For example, in the examples described herein, hinges 14 include one or more components that allow hinges 14 to be mechanically coupled to both wall 18A and door 20, in addition to one or more rotating portions within a middle section of hinges 14 that facilitate rotation of door 20 about a fixed axis of rotation. In this way, hinges 14 can be mechanically coupled to both wall 18A and door 20 and allow rotation of door 20 with respect to wall 18A, which can result in opening and closing of door 20.

In the example illustrated in FIG. 1, angle 11 is an angle between the outer, e.g., external, surface of door 20 and the outer, e.g., external, surface of wall 18A. In the example illustrated in FIG. 1, door 20 is in a closed position when door 20 has rotated to create angle 11 of approximately 270 degrees with top wall 18A, as illustrated by the directional arrow in FIG. 1. In the example shown in FIG. 1, in an open position, a plane defined by door 20 may be positioned at an angle of about 0 degrees to about 269 degrees with respect to a major surface of wall 18A.

In some examples, hinges 14 may be configured such that hinges 14 allow a limited angle 11 of rotation between door 20 and wall 18A to which door 20 is mechanically coupled. That is, hinges 14 may restrict the amount of rotation between door 20 and wall 18A by allowing door 20 to rotate only a particular amount to a fixed position. For example, in some examples, hinges 14 may restrict rotation of door 20 with respect to wall 18A to less than 90 degrees. In other examples, hinges 14 may allow greater than 90 degrees of rotation between door 20 and wall 18A.

Hinges 14 may be formed in any suitable configuration. For example, hinges 14 may be formed as any particular type of hinge, e.g., barrel hinges, butt hinges, continuous hinges, and/or butterfly hinges, that can create a fixed axis of rotation around which door 20 can rotate. In addition, hinges 14 may be formed from any particular material suitable for providing a reliable mechanical connection between door 20 and wall 18A. For example, in some examples, hinges 14 are formed from a rigid metal, e.g., steel or aluminum, that can resist deformation and damage caused by extensive use, applied forces, or external factors, e.g., environmental factors. In other examples, hinges 14 may be formed from another material, such as a rigid plastic, e.g., polypropylene.

In some examples, assembly 10 includes a fastener, e.g., a latch or a lock, that can secure door 20 in a closed position. In some examples, closing door 20 may substantially completely enclose the cavity created by container 12 configured to contain one or more articles, and engaging a fastener can provide added protection against unauthorized entry into container 12. As an example, a fastener may include a first component mechanically coupled to door 20 and a second component positioned on and mechanically coupled to bottom wall 18B (partially shown in FIG. 1 with phantom lines), which may be the wall 18 of container 12 with the smallest z-axis position), and the second component can be configured to interact with the first component in order to secure door 20 and bottom wall 18 to one another and to maintain door 20 in a closed position. As another example, the fastener may be an adhesive applied between door 20 and one or more of walls 18 in contact with a surface of door 20.

In the examples described herein, cable 16 extends through hinges 14 between wall 18A and door 20 in a manner suitable for detecting rotation of hinge 14, which may be correlated to opening of door 20 and to a possible tamper event. Because hinges 14 are positioned to permit opening and closing of door 20, rotation of hinges 14 can be correlated to opening and/or closing of door 20. In addition, because cable 16 extends through hinges 14, properties of the signal transmitted by cable 16 may be modulated by rotation of hinges 14, e.g., as the configuration (e.g., shape) of cable 16 within hinges 14 changes with the rotation of hinges 14. Consequently, detecting changes in the properties of the signal can help to detect possible tamper events.

Cable 16 may be embedded within or otherwise mechanically coupled to one or more walls 18 of container 12, such as one wall 18, two walls, or up to all five walls. In the example illustrated in FIG. 1, cable 16 is embedded within wall 18A and door 20, and extends through hinges 14 between wall 18A and door 20. In the example shown in FIG. 1, cable 16 may be secured on or within wall 18A and door 20. For example, cable 16 may be secured to an inner surface (e.g., facing the inside of the cavity of container 12) of one or more walls 18 and door 20, or within one or more walls 18 and door 20. In these examples, cable 16 may be positioned such that cable 16 is not visible from the outside of container 12. In addition, cable 16 may have a relatively low profile (e.g., may not protrude significantly into the cavity of container 12) so as not to interfere with articles (e.g., equipment) housed by container 12.

In some examples, cable 16 may be embedded within wall 18A and door 20 on either side of hinge 14. For example, wall 18A and door 20 may each define an inner surface and an outer surface, where the inner surface is defined as the surface of wall 18A or door 20 that is proximate to the cavity defined by container 12 and the outer surface is defined as the surface of wall 18A or door 20 that faces outward from the cavity defined by container 12. Cable 16 can be positioned between the inner surface and the outer surface in order to detect tampering with the surface of wall 18A and door 20, e.g., to detect drilling into the surfaces. In examples in which cable 16 is at least partially embedded within wall 18A and/or door 20, the embedded portion of cable 16 may not be visible from either the inside of container 12 or the outside of container 12. When embedded in one or more walls 18 and/or door 20, cable 16 can be substantially fixed in the material that defines walls 18 and/or door 20, such that the portion of the embedded cable is substantially closely surrounded on all sides by the material. Additional example configurations of tamper sensors positioned within one or more walls of a container are described in commonly-assigned U.S. Patent Application Publication No. 2008/0129501 by Tucker et al., entitled “SECURE CHASSIS WITH INTEGRATED TAMPER DETECTION SENSOR,” filed on Nov. 30, 2006 and herein incorporated by reference in its entirety.

In the example illustrated in FIG. 1, a single cable 16 passes through wall 18A, hinges 14, and door 20. In other examples, more than one cable 16 may be integrated into walls 18, door 20, and hinges 14 of container 12, whereby each of the cables 16 extends through hinge 14 between door 20 and one or more walls 18. In addition, in some examples, a single cable 16 may extend through a plurality of walls 18 and door 20 instead of extending through only one wall 18A and door 20.

In the examples described herein, cable 16 is configured and positioned relative to container 12 to transmit a signal along a path that extends along wall 18A (e.g., in a direction substantially parallel to a major surface of wall 18A), through hinges 14, and along door 20 (e.g., in a direction substantially parallel to a major surface of door 20). Because cable 16 extends at least partially through hinges 14, the signal transmitted by cable 16 may be modulated, e.g., one or more characteristics (e.g., the amplitude, frequency, or strength) of the signal may change, based on movement of hinges 14, such as rotation of hinges 14. For example, as hinges 14 open and close, the pathway for the signal may change length or attributes (e.g., shape or size), thereby changing the characteristics of the signal that propagates through cable 16. As an example, in some examples, the signal may be an optical signal, and the strength of the signal may depend on the diameter of cable 16. For example, cable 16 with a smaller diameter, e.g., resulting from deformation of cable 16 caused by rotation of hinge 14, may result in higher attenuation of the signal transmitted through cable 16. That is, in these examples, the optical signal strength may be lower because a higher percentage of the optical signal is attenuated. In some cases, movement of hinges 14 may signify that door 20 has been opened or closed, which may indicate that a tamper event has or may have occurred. Consequently, monitoring the signal transmitted by cable 16 through a pathway that traverses through hinge 14 may provide an effective mechanism for detecting a possible tamper event.

In some examples, assembly 10 includes one or more signal transmitters that can transmit a signal through cable 16. The signal transmitters may be positioned within the cavity of container 12 or may be external to the cavity. In addition, assembly 10 may also include one or more sensors that detect the signal transmitted through cable 16 and one or more processors that can detect changes in one or more characteristics of the signal. The sensors and processors may be positioned within the cavity of container 12 or may be external to the cavity. If one or more characteristics of a signal transmitted from the signal transmitter to the sensor through cable 16 correlates to a change in properties of the signal, the processors may determine that hinge 14 has rotated, e.g., that door 20 has been opened, and one or more components of assembly 10 may take a defensive action in order to protect one or more articles stored within container 12. Examples of defensive actions are described below.

As an example, cable 16 may be a fiber optic cable that transmits a light signal. Assembly 10 may include one or more signal transmitters that transmit an optical signal through cable 16, e.g., one or more optoelectronic devices such as a light-emitting diode or a laser diode. In addition, assembly 10 may include one or more sensors that receive light through cable 16, such as one or more photodiodes. The one or more sensors can detect the light and generate an electrical signal that is modulated as a function of one or more properties of the light transmitted through cable 16 and detected by the one or more sensors. For example, the one or more sensors (e.g., photodiodes) may convert light incident on a detection surface of the sensors into either a current or voltage, which may be outputted as an electrical signal. An intensity of the signal received by the processor may be indicative of the state of door 20 (e.g., an open state or closed state). That is, a change in properties of the light signal, e.g., as demonstrated by the sensor measurements, may signify that hinge 14 has rotated. For example, the one or more processors may detect changes in the intensity, phase, polarization, wavelength, brightness, and/or transit time of the light within cable 16 based on the measurements taken by the one or more sensors. In some examples, cable 16 itself may include the one or more sensors while, in other examples, the one or more sensors may be coupled to cable 16 but may be components separate from cable 16.

In examples in which cable 16 is a fiber optic cable, the one or more sensors of assembly 10 can measure properties of the optical signal transmitted through fiber optic cable 16. For example, in some examples, the sensors can measure intensity or brightness of the optical signal and convert the measurements into an electrical signal that can be received by and analyzed by a processor, e.g., a processor of assembly 10. In other examples, the sensors can measure an optical pattern at a defined amplitude, frequency, and/or wavelength. In examples in which cable 16 is a fiber optic cable, the one or more sensors can be implemented as any suitable photo-sensitive sensors. For example, the one or more sensors may be implemented as charge coupled devices (CCD) with photodiodes. Additional examples of sensors that can detect changes in properties of an optical signal that may be indicative of a tamper event are discussed in commonly-assigned U.S. Patent Application Publication No. 2008/0073491 by Fleischman et al. entitled “ANTI-TAMPER ENCLOSURE SYSTEM” and filed on Sep. 21, 2007, which is herein incorporated by reference in its entirety.

As another example, in some examples, cable 16 may be an electrical cable, e.g., an electrically conductive wire, that transmits an electrical signal that changes one or more characteristics (e.g., a frequency or amplitude) based on movement of cable 16. The one or more signal transmitters of assembly 10 may include one or more signal generators that transmit electrical signals through cable 16, in addition to one or more sensors that receive electrical signals through cable 16. One or more processors of assembly 10 can determine whether the properties of the electrical signal transmitted through cable 16 have changed based on the measurements of the one or more sensors, which may signify that hinge 14 has rotated. For example, the one or more processors may detect changes in the frequency, phase, and/or amplitude of the electrical signal within cable 16.

In examples in which cable 16 is an electrical cable, the one or more sensors can measure properties of the electrical signal transmitted through electrical cable 16. For example, the one or more sensors may sense the electrical signal after it is transmitted from one end of cable 16 on one side of hinge 14, through the portion of hinge 14 extending through hinge 14, and to the other end of cable 16 on the other side of hinge 14. A processor, e.g., a processor of assembly 10, can receive the sensed signal and determine whether properties (e.g., a voltage or current amplitude or frequency) of the electrical signal have changed, which may signify that hinge 14 has rotated.

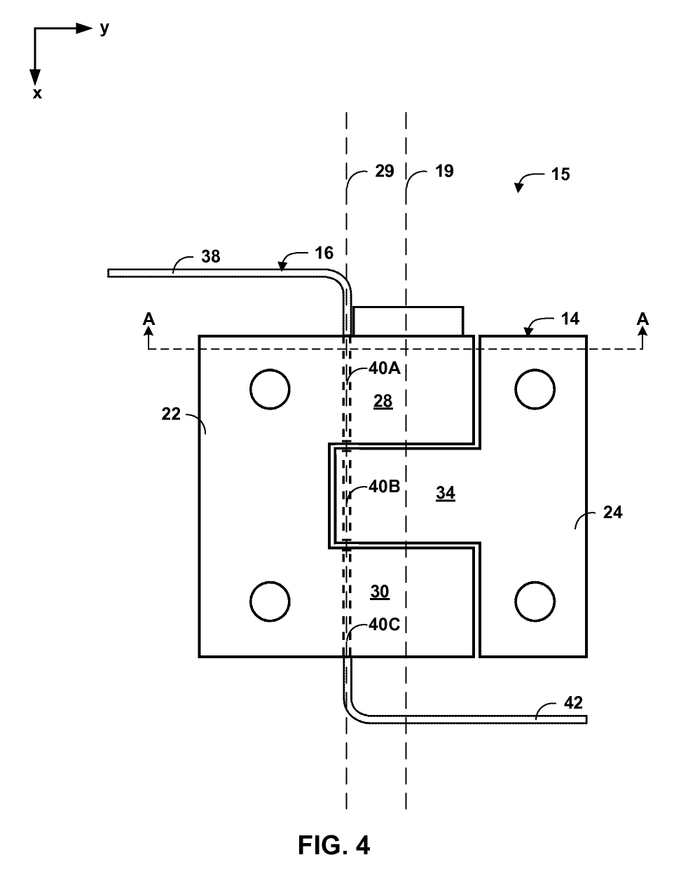

As one example, a discontinuity in cable 16 that results from rotation of hinge 14 may cause the electrical signal transmitted through cable 16 to be interrupted, such that the electrical signal that is transmitted through cable 16 is interrupted (e.g., not transmitted through the entire portion of cable 16 extending through hinge 14) or otherwise modulated (e.g., only a portion of the electrical signal may be transmitted through the portion of cable 16 extending through hinge 16, and, therefore, the sensed electrical signal strength may be lower than the strength of the transmitted electrical signal). For example, as described in further detail below with respect to FIGS. 4, 5, 6A, and 6B, cable 16 may be defined by multiple segments that are positioned within hinge 14 such that the segments rotate out of alignment with one another upon rotation of hinge 14. The signal transmitted through cable 16 may be an electrical signal, and may be interrupted because of the discontinuity. The sensors of the assembly 10 may subsequently sense the signal interruption, and the processor may determine that hinge 14 has rotated based on detecting the interruption.

Assembly 10 may also include one or more processors that receive the signal (e.g., an electrical or optical signal) generated and/or sensed by a sensor and determines, based on the signal, whether a possible tamper event has occurred. For example, assembly 10 may include one or more processors that compare a characteristic of the sensed signal to a predetermined value in order to determine whether the properties of the signal transmitted through cable 16 indicate door 20 has been opened. If the characteristic of the signal from sensor 56 does not substantially match the predetermined value, the one or more processors may determine that a possible tamper event has occurred, e.g., that door 20 has been opened. In some examples, the predetermined value may be an average value of the signal characteristic for a particular number, e.g., ten, of prior measurements.

The one or more processors of assembly 10 may include any one or more microprocessors, controllers, digital signal processors (DSPs), application specific integrated circuits (ASICs), field-programmable gate arrays (FPGAs), and discrete logic circuitry. The functions attributed to the one or more processors described herein may be provided by a hardware device and embodied as software, firmware, hardware, or any combination thereof.

Upon identification of a possible tamper event, the one or more processors can store an indication of the occurrence of the tamper event. In addition or instead, in some examples, the one or more processors may initiate a defensive action to protect the one or more articles housed within container 12. In some examples, the processors may initiate a defensive action after a particular number of possible tamper events have occurred, e.g., after two or more possible tamper events.

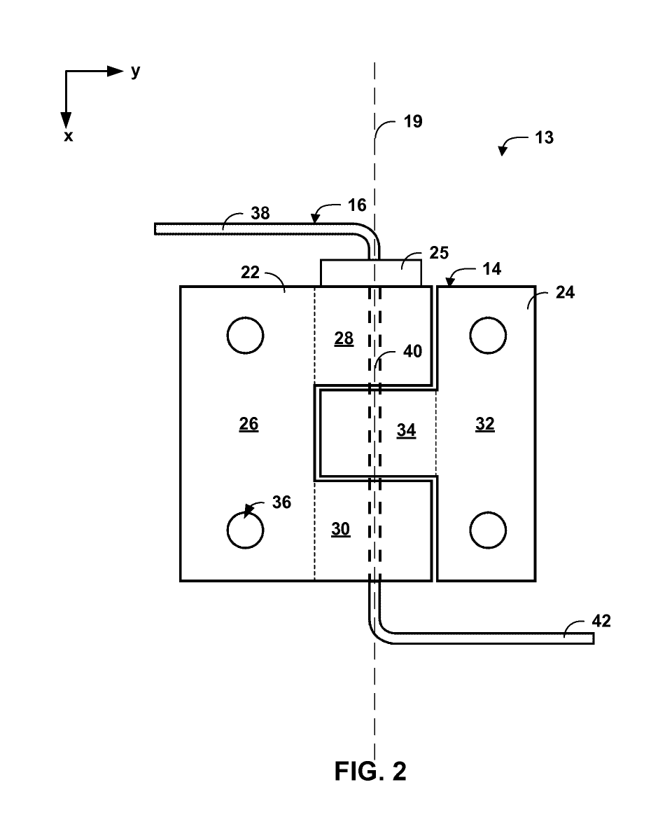

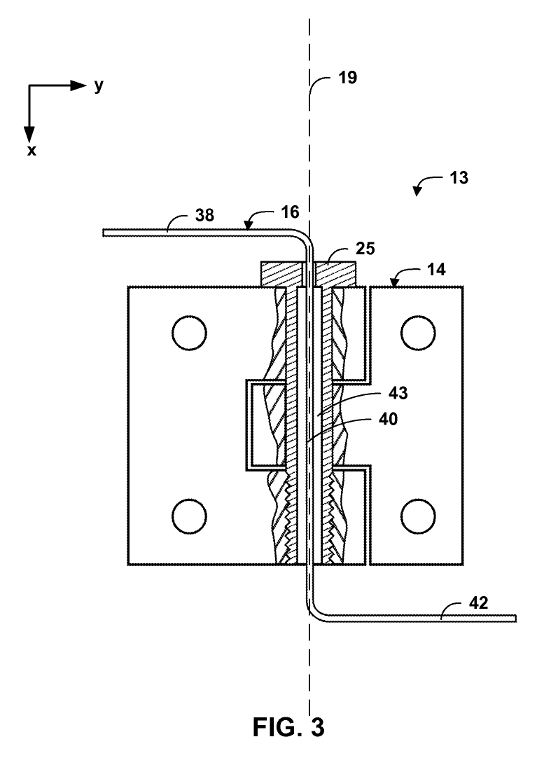

FIGS. 2 and 3 illustrate a first example configuration of a tamper-indicating system 13. In the examples herein, tamper-indicating system 13 includes cable 16 extending at least partially through hinge 14, and several example configurations of tamper-indicating system 13 are described. In the example configuration shown in FIGS. 2 and 3, cable 16 extends through hinge 14 along axis of rotation 19. As described herein, axis of rotation 19 an axis around which hinge 14 rotates, e.g., the axis around which door 20 rotates open and closed. In the example illustrated in FIGS. 2 and 3, hinge 14 is formed by two components 22 and 24 coupled together via a fastener 25 that extends through axis of rotation 19. In other examples, hinge 14 may include only one component, or may include more than two components. While FIGS. 2 and 3 illustrate one hinge 14, in other examples, tamper-indicating system 13 may include cable 16 extending through more than one hinge 14, or a plurality of cables 16 extending through a respective hinge 14 that mechanically couples door 20 (FIG. 1 to a wall 18 of a container.

FIG. 2 is a schematic side view of one hinge 14 with cable 16 extending along axis of rotation 19. FIG. 2 illustrates hinge 14 when door 20 is in an open position such that door 20 and wall 18A are positioned in substantially the same plane, e.g., angle 11 (FIG. 1) between door 20 and wall 18A is approximately 180 degrees. Consequently, the side view shown in FIG. 2 is taken in the x-y plane of FIG. 1 (orthogonal x-y axes are shown for purposes of description only.)

As shown in FIG. 2, component 22 of hinge 14 defines mounting surface 26 and rotating portions 28 and 30, and component 24 defines mounting surface 32 and rotating portion 34. Mounting surfaces 26 and 32 can be mechanically coupled to wall 18A and door 20, respectively, via a substantially rigid connection, and are configured to mount hinge 14 to wall 18A and door 20. In the examples herein, component 22 of hinge 14 is described as being mounted to wall 18A and component 24 of hinge 14 is described as being mounted to door 20. In other examples, component 24 may be mounted to wall 18A and component 22 may be mounted to door 20. In other examples, each of components 22 and 24 may be mounted to a respective door 20, where hinge 14 allows the doors 20 to rotate with respect to one another.

Mounting surfaces 26 and 32 of components 22 and 24, respectively, may be mechanically coupled to wall 18A and door 20 via any suitable mechanism. For example, in the example illustrated in FIGS. 2 and 3, each of mounting surfaces 26 and 32 defines a pair of apertures 36, which are configured to accept a mounting component. The mounting components mechanically couple mounting surfaces 26 and 32 to wall 18A and door 20, respectively. In some examples, the mounting components may be screws or bolts. Wall 18A and door 20 may be formed with predefined apertures into which the screws or bolts can be inserted and secured, or the screw and/or bolt may define the apertures in wall 18A and/or door 20 as the screw and/or bolt is introduced into wall 18A and/or door 20. In either case, the mounting components may extend through apertures 36 of hinge 14 and into wall 18A and door 20 in order to mount hinge 14 to wall 18A and door 20. Additionally or alternatively, hinge 14 can be mechanically coupled to wall 18A and door 20 via another mechanism suitable for providing a reliable mechanical connection between hinge 14 and wall 18A and door 20. For example, in some examples, mounting surfaces 26, 32 or another portion of hinge 14 may be mechanically coupled to wall 18A and door 20 via an adhesive, e.g., epoxy.

In the example illustrated in FIG. 2, hinge 14 includes rotating portions 28, 30, and 34 which function cooperatively to allow door 20 to rotate open and closed around axis of rotation 19. Rotating portions 28 and 30 extend in a substantially positive y-axis direction from mounting surface 26 of component 22, and rotating portion 34 extends in a substantially negative y-axis direction from substantially the center of mounting surface 24 in the x-y plane. Rotating portion 34 of component 24 is configured to be positioned between rotating portions 28 and 30 of component 22. In this way, rotating portions 28, 30, and 34 are interpositioned and aligned along an axis of rotation 19. In the example illustrated in FIG. 2, axis of rotation 19 runs in the x-axis direction. Rotating portion 34 is configured to move with respect to rotating portions 28, 30, which, in the example shown in FIG. 2, are fixed relative to each other.

In the examples described herein, hinge 14 also includes a rigid fastener 25 extending through rotating portions 28, 30, and 34 along axis of rotation 19. Rotating portions 28, 30, and 34 may define apertures through which the fastener 25 can extend in order to align and mechanically couple rotating portions 28, 30, and 34 to one another. When component 24 is positioned such that rotating portion 34 is received in an opening defined between rotating portions 28, 30, as illustrated in FIGS. 2 and 3, the apertures defined within each of the rotating portions 28, 30, and 34 generally align to form an extended aperture along axis of rotation 19 into which the fastener 25 can be positioned. Fastener 25 can mechanically couple components 22 and 24 to one another and substantially restrict relative motion of components 22 and 24 such that components 22 and 24 rotate along axis of rotation 19.

In some examples described herein, fastener 25 is configured as a substantially rigid bolt that passes through the apertures defined by rotating portions 28, 30, and 34 of hinge 14. For example, fastener 25 may be formed from a substantially rigid material, such as a rigid metal or plastic, which can provide a substantially rigid mechanical connection between components 22 and 24 of hinge 14, while still permitting rotational movement of components 22, 24 relative to each other about a common axis of rotation 19. In other examples, fastener 25 may be configured in a different manner such that fastener 25 mechanically couples the rotating portions of hinge 14. In yet other examples, hinge 14 may not require fastener 25. For example, in some examples, hinge 14 may be formed as a single component that does not require mechanical coupling.

Rotating portion 34 of component 24 rotates around axis of rotation 19 in order to facilitate opening of door 20. For example, in some examples, rotating portion 34 defines an aperture through which fastener 25 extends, and rotating portion 34 rotates around fastener 25. Because mounting surface 32 is mechanically coupled to door 20, a force exerted on door 20 to open and/or close door 20 causes rotation of rotating portion 34 about axis of rotation 19, which allows opening and/or closing of door 20 about axis of rotation 19.

In the example illustrated in FIGS. 2 and 3, cable 16 extends through hinge 14 generally in a direction substantially parallel to, and, in some examples, coaxial with, axis of rotation 19. In some examples, cable 16 may extend through a portion of hinge 14 such that cable 16 is substantially free to move within hinge 14. For example, cable 16 may extend through an aperture predefined within hinge 14 and may be substantially free to move within the aperture. In some examples, cable 16 may be anchored on either side of hinge 14, e.g., secured to wall 18A and door 20, but may be substantially free to move within the aperture defined within hinge 14. In other examples, cable 16 may be substantially secured within hinge 14 and may not be free to move within hinge 14. For example, in some examples, cable 16 may be anchored to hinge 14 via a fastening element, e.g., an adhesive, which secures cable 16 within hinge 14 and substantially prevents cable 16 from moving within hinge 14. In other examples, hinge 14 may be formed such that cable 16 is an integral component of hinge 14. For example, hinge 14 may define an aperture characterized by substantially the same dimensions as cable 16, e.g., the same diameter, such that cable 16 fits securely within the aperture and is substantially prevented from moving within hinge 14.

In FIG. 2, a portion of cable 16 that extends through hinge 14 is represented by hidden lines extending along axis of rotation 19. Cable 16 includes segments 38, 40, 42, which are described in further detail below. Segments 38, 40, 42 may be substantially contiguous and may have substantially similar cross-sectional dimensions, such that segments 38, 40, 42 define a substantially continuous longitudinal surface of cable 16. In other examples, however, segments 38, 40, 42 may have different cross-sectional sizes, and/or may be separated by another cable segment. Segments 38, 40, 42 may have different lengths.

In the example illustrated in FIGS. 2 and 3, segment 38 of cable 16 is configured to extend between wall 18A (not shown in FIGS. 2 and 3) and hinge 14. In some examples, segment 38 is mechanically coupled to wall 18A such that segment 38 is secured on or within wall 18A. For example, segment 38 may be embedded within wall 18A, such that at least a portion of a longitudinal surface of segment 38 (extending in a direction along a length of cable 16), and in some cases, all longitudinal surfaces of segment 38 are substantially surrounded by material defining wall 18A.

Similarly, segment 42 of cable 16 is configured to extend between hinge 14 and door 20 (not shown in FIGS. 2 and 3). In some examples, segment 42 is mechanically coupled to door 20 such that segment 42 is secured on or within door 20. For example, segment 42 may be embedded within door 20, such that at least a portion of a longitudinal surface of segment 42 (extending in a direction along a length of cable 16), and in some cases, all longitudinal surfaces of segment 42 are substantially surrounded by material defining door 20.

Between segments 38 and 42, cable 16 defines segment 40, which extends through hinge 14 along axis of rotation 19. Segment 40 of cable 16 is represented by hidden lines in FIG. 2 As described herein, axis of rotation 19 extends through substantially the center of hinge 14 in a substantially y-axis direction.

In examples in which hinge 14 includes fastener 25 positioned through apertures defined by rotating portions 28, 30, and 34 of hinge 14, segment 40 of cable 16 may extend through fastener 25. For example, fastener 25 may define an aperture that extends along a substantially central axis of fastener 25, and cable 16 can extend through the aperture. In this way, cable 16 can extend substantially through hinge 14 along axis of rotation 19. In other examples, such as examples in which hinge 14 does not include a fastener, cable 16 may extend through hinge 14 via an aperture defined within another portion of hinge 14 that extends along axis of rotation 19.

In some examples, segments 38, 42 of cable 16 may be mechanically coupled to wall 18A and door 20, respectively, such that as door 20 moves relative to wall 18A, segments 38, 42 of cable 16 also move relative to each other. For example, in some examples, segment 38 may be at least partially embedded within wall 18A, and segment 42 may be at least partially embedded within door 20. As a result of the mechanical coupling of segments 38, 42 to wall 18A and door 20, respectively, portions of segments 38 and 42 may have little to no range of motion relative to wall 18A and door 20. In contrast, segment 40, extending along axis of rotation 19, may be at least partially free to move within hinge 14. For example, in the example configuration illustrated in FIGS. 2 and 3, segment 40 may not be mechanically coupled to hinge 14 and may be free to move with respect to hinge 14. However, in some examples, segments 38 and 40 are mechanically coupled to wall 18A and door 20, respectively, which maintains segment 40 positioned within hinge 14.

Rotation of hinge 14 about the rotation of axis may cause segment 40 of cable 16, which extends through hinge 14, to move. For example, because segments 38 and 42 on either side of segment 40 are mechanically coupled to wall 18A and door 20, and segment 40 is substantially free to move within hinge 14, segment 40 may move within hinge 14 as a result of movement of component 24 of hinge 14 resulting from rotation of door 20.

The properties of the signal transmitted through cable 16 may change based on movement of cable 16. For example, in examples in which cable 16 is or includes a fiber optic cable, a change in position of segment 40 of cable 16 may change the intensity, phase, polarization, wavelength, brightness, and/or transit time of light through cable 16. As another example, in examples in which cable 16 is an electrical cable, a change in position of segment 40 may change the frequency, phase, and/or amplitude of the electrical signal transmitted through cable 16. One or more sensors of assembly 10 may sense the signal transmitted through cable, and one or more processor of assembly 10 can identify changes in signal properties. In some examples, the processors or another component of assembly 10 can identify a possible tamper event based on the changes in signal properties.

In some examples, segment 40 of cable 16 may be configured with a strain-relief mechanism to accommodate changes in the distance between segments 38, 42 upon opening and/or closing of door 20, which may help prevent damage to segment 40 upon opening and/or closing of door 20. For example, segments 38 and 42 may be secured on or within wall 18A and door 20, respectively, on either side of segment 40. Consequently, segment 40 may experience strain and stretching as a result of opening and closing of door 20. In order to prevent damage to cable 16, segment 40 may be configured in such a way as to relieve the strain caused by stretching of segment 40.

Any suitable strain-relief mechanism may be incorporated into system 13. For example, in some examples, segment 40 may be configured with a counter-twist strain-relief mechanism that may help prevent breakage of cable 16 from repetitive application of strain resulting from movement of segments 38, 42 of cable 16 relative to each other. For example, segment 40 may be in a stretched state upon closing of door 20 because angle 11 (FIG. 1) between wall 18A and door 20 may be greatest when door 20 is closed. In order to relive strain on cable 16 caused by closing of door 20, segment 40 may be formed such that segment 40 returns to a counter-twisted state upon closing of door 20. Segment 40 configured in the counter-twisted state (e.g., when door 20 is closed) may span substantially the same distance within hinge 14 as segment 40 configured in an extended state (e.g., when door 20 is opened), yet accommodate changes in distance between segments 38, 42 of cable 16 when door 20 opens and closes.

In some examples, including segment 40 configured with a counter-twist can maintain the sensitivity of cable 16 more effectively than a configuration in which segment 40 is configured to simply include added slack to relieve strain on cable 16. For example, in some examples, a longer cable 16 may be less sensitive than a shorter cable 16 and the signal transmitted via a longer cable 16 may be more susceptible to degradation by signal noise because the signal is required to travel over a longer distance. In addition, loose portions of a longer cable 16, e.g., slack, can contact each other and create unintended signal pathways, which may disrupt the signal transmitted through cable 16. Consequently, a shorter cable 16 and, more specifically, a shorter segment 40 may, in some examples, be more desirable because the integrity of the signal transmitted through cable 16 may be relatively well-maintained.

As another example of a strain-relief mechanism, cable 16 can be formed from an at least partially elastic material, e.g., rubber, that can repeatedly expand and contract. Upon opening or closing of door 20, elastic cable 16 can correspondingly lengthen or shorten in order to prevent damage to or breakage of cable 16.

FIG. 3 illustrates a schematic cross-sectional view of the example configuration of tamper-indicating system 13 shown in FIG. 2. As illustrated, tamper-indicating system 13 includes cable 16 extending through hinge 14 along axis of rotation 19 of hinge 14. In the example illustrated in FIG. 3, fastener 25 extends along axis of rotation 19 through rotating portions 28, 30, and 34 of hinge 14. In the example illustrated in FIG. 3, fastener 25 defines aperture 43 through which segment 40 of cable 16 extends.

Segment 38 of cable 16 is configured to be secured on or within wall 18A of container 12 on a first side of hinge 14, such that segment 38 is substantially fixed relative to wall 18A. Segment 42 of cable 16 is configured to be secured on or within door 20 of container 12 on a second side of hinge 14, such that segment 42 moves relative to wall 18A as door 20 moves relative to wall 18A. As discussed above, wall 18A and door 20 are mechanically coupled together via hinge 14. In some examples, segment 40 of cable 16 is substantially free to move within aperture 43 of fastener 25. Thus, the configuration of segment 40 may change based on rotation of hinge 14. For example, closing of door 20 may cause segment 42 of cable 16 to rotate around axis of rotation 19, and, in some examples, move closer to hinge 14 because segment 42 is secured on or within door 20. As door 20 closes, door 20 and segment 42 move closer to wall 18A, thereby lengthening the distance between segments 38, 42, in examples in which hinge 14 is mechanically coupled to the outer surface of container 12. In this way, movement of door 20 relative to wall 18A may cause the distance over which segment 40 of cable 16 extends within hinge 14 to change (e.g., decrease as door 20 opens and increase as door 20 closes) because the angle 11 (FIG. 1) between door 20 and wall 18A has changed. The configuration of segment 40 (e.g., effective length or path through hinge 14) may change as a result of the change in distance, which may change the properties of the signal transmitted through segment 40 and cable 16.

Segment 40 may stretch as door 20 closes in order to accommodate the increase in distance, e.g., the increased angle 11, between segment 38 and 42. As discussed with respect to FIG. 2, segment 40 may be configured with a strain-relief mechanism such that the integrity of cable 16 is maintained upon stretching and unstretching of segment 40 that can result from opening and/or closing of door 20. For example, when door 20 is in an open position, segment 40 may have a twisted configuration, e.g., segment 40 may be twisted along axis of rotation 19. The twisted configuration can provide additional cable length for segment 40 while maintaining the same overall length (e.g., the length through aperture 42), where the additional cable length may be utilized upon closing of door 20. The additional cable length built into segment 40 may help minimize the amount of strain and stretching sustained by segment 40 as door 20 opens and closes.

FIGS. 4, 5, 6A, and 6B illustrate another example configuration of tamper-indicating system 15 that includes cable 16 extending through hinge 14 along an axis apart from (e.g., not coaxial with), but substantially parallel to, axis of rotation 19. For example, as illustrated in FIG. 4, cable 16 extends along an axis that is positioned slightly off-center relative to axis of rotation 19 of hinge 14. In the example illustrated in FIG. 4, a processor of system 10 can detect movement of cable 16, e.g., movement of cable 16 that correlates to rotation of hinge 14 and relative movement of wall 18A and door 20, by detecting that a discontinuity exists in cable 16. For example, the processor may detect interruption of the signal transmitted by cable 16 that could result from a discontinuity in cable 16.

In the example illustrated in FIGS. 4-6, hinge 14 includes component 22 that defines mounting surface 26 and rotating portions 28 and 30 (also shown in the example illustrated in FIGS. 2, 3), and component 24 that defines mounting surface 32 and rotating portion 34 (also shown in the example illustrated in FIGS. 2, 3). Hinge 14 is configured in a substantially similar manner to hinge 14 illustrated in FIGS. 2, 3. For example, as described above with respect to FIG. 2, rotating portion 34 rotates around axis of rotation 19 in order to facilitate opening and closing of door 20 of assembly 10.

In the example configuration illustrated in FIGS. 4-6, cable 16 may include two or more distinct segments that, when aligned, define a substantially continuous signal pathway that can transmit a signal through hinge 14. As a result of opening and/or closing of door 20, the segments may be displaced such that the segments are not aligned and separated from each other, which may result in an interruption or other change in the signal pathway, and, therefore, an interruption or other change in the signal transmitted through cable 16. That is, rotation of hinge 20 resulting from opening of door 20 may cause the segments of cable 16 to rotate apart from one another, breaking the optical or electrical connection between the segments of cable 16 and causing an interruption in transmission of the signal through cable 16. In these examples, a processor of assembly 10 can detect a possible tamper event by detecting the interruption or change in the signal resulting from separation of the segments of cable 16.

As illustrated in FIG. 4, cable 16 extends through hinge 14 along axis 29 substantially parallel to but separate from axis of rotation 19, e.g., an axis 29 that is displaced from axis of rotation 19 in a substantially positive or negative y-axis direction in FIG. 4. That is, segment 40 of cable 16 extending through hinge 16 is not coaxial with an axis of rotation 19 of rotating portions 28, 30, 34 of hinge 14. As illustrated in FIG. 4, cable 16 includes segment 38 configured to extend between wall 18A and hinge 14, segments 40A, 40B, and 40C that extend substantially through hinge 14 in a generally x-axis direction, and segment 42 configured to exit hinge 14 and extend between door 20 and hinge 14. As also described with respect to the example configuration illustrated in FIGS. 2 and 3, segment 38 may be mechanically coupled to wall 18A and segment 42 may be mechanically coupled to door 20. Segments 38 and 42 of FIGS. 4-6 may be substantially similar to segments 38 and 42 described with respect to FIGS. 2, 3.

As illustrated in FIG. 4, in the example configuration described with respect to FIGS. 4-6, segments 40A-40C extend substantially through hinge 14 in an x-axis direction. Segments 40A and 40C are positioned within component 22 of hinge 14, which is mechanically coupled to wall 18A. Segment 40C is positioned within component 24, which is mechanically coupled to door 20. In some examples, segment 40A is mechanically coupled to rotating portion 28, segment 40B is mechanically coupled to rotating portion 34, and segment 40C is mechanically coupled to rotating portion 30. Consequently, segments 40A-40C rotate with rotating portions 28, 30, and 34, respectively. That is, when rotating portions 28, 30, and 34 rotate with respect to one another, segments 40A-40C also rotate because segments 40A-40C are mechanically coupled to rotating portions 28, 30, and 34 within rotating portions 28, 30, and 34. When door 20 is in a closed position, segments 40A, 40B, and 40C are substantially aligned along axis 29 that extends through rotating portions 28, 30, and 34 of hinge 14. In this way, when door 20 is in a closed position, segments 40A, 40B, 40C define a substantially continuous pathway for an optical signal (e.g., in the case of a fiber optic cable) or an electrical signal (e.g., in the case of an electrical conductor) to traverse through cable 16.

When door 20 and hinge 14 rotate to an open position, segment 40B, within component 24, rotates away from segments 40A and 40C, disrupting the alignment of segments 40A, 40B, and 40C of cable 16 and breaking up the substantially continuous pathway for an optical signal or an electrical signal defined by cable 16. The misalignment of segments 40A, 40B, and 40C causes the signal transmitted through cable 16 to be interrupted or otherwise changed because the path along which the signal is transmitted has been disrupted. A processor of assembly 10 may detect a potential tamper event (e.g., the opening of door 20) based on interruption of the signal or other change in the signal. In some examples, the processor or another component of assembly 10 performs a defensive action, such as transmitting an alert (e.g., activating an alarm such as a high decibel siren or transmitting an alert to a remotely located person or device via wired or wireless communication techniques), destroying assembly 10, destroying one or more articles stored within container 12, disabling one or more articles stored by container 12, and/or disabling the assembly 10 in response to determining that a potential tamper event has occurred.

In the example described with respect to FIG. 4, rotating portions 28, 30, and 34 may define apertures through which segments 40A, 40B, and 40C can extend. For example, rotating portion 28 may define an aperture through which segment 40A can extend, rotating portion 34 may define an aperture through which segment 40B can extend, and rotating portion 30 may define an aperture through which segment 40C can extend. For example, prior to assembly of tamper-indicating system 15, apertures may be defined within rotating portions 28, 30, and 34 for segments 40A-40C.

In examples in which a processor of assembly 10 detects movement of cable 16, e.g., movement of cable 16 that correlates to rotation of hinge 14 and relative movement of wall 18A and door 20, by detecting that a discontinuity exists in cable 16, cable 16 may be specifically configured for repetitive connection and disconnection. For example, in examples in which cable 16 is a fiber optic cable, cable 16 may include one or more optical fiber connectors that can enable rapid and repetitive connection and disconnection of portions of cable 16 while maintaining the integrity of cable 16. The optical fiber connectors can mechanically couple and align the portions of cable 16 such that an optical signal can pass through fiber optic cable 16.

As another example, cable 16 may be an electrical cable, and cable 16 may be equipped with any connectors suitable for mechanically and electrically coupling and aligning segments 40A, 40B, and 40C of cable 16 such that an electrical signal can effectively pass through cable 16. For example, in some examples, cable 16 may be a metallic electrical cable, e.g., a conductive wire, and cable 16 may include portions of magnetic material at the interfaces between each of segments 40A, 40B, and 40C of cable 16. The magnetic material can cause the adjacent segments 40A, 40B, and 40C to be magnetically attracted to one another, which can prevent the adjacent segments from separating when aligned and can increase the reliability of the electrical connection throughout electrical cable 16. In the example illustrated in FIG. 4, assembly 10 may include one or more optical fiber or electrical connectors positioned between segments 40A and 40B of cable 16 and between segments 40B and 40C of cable 16.

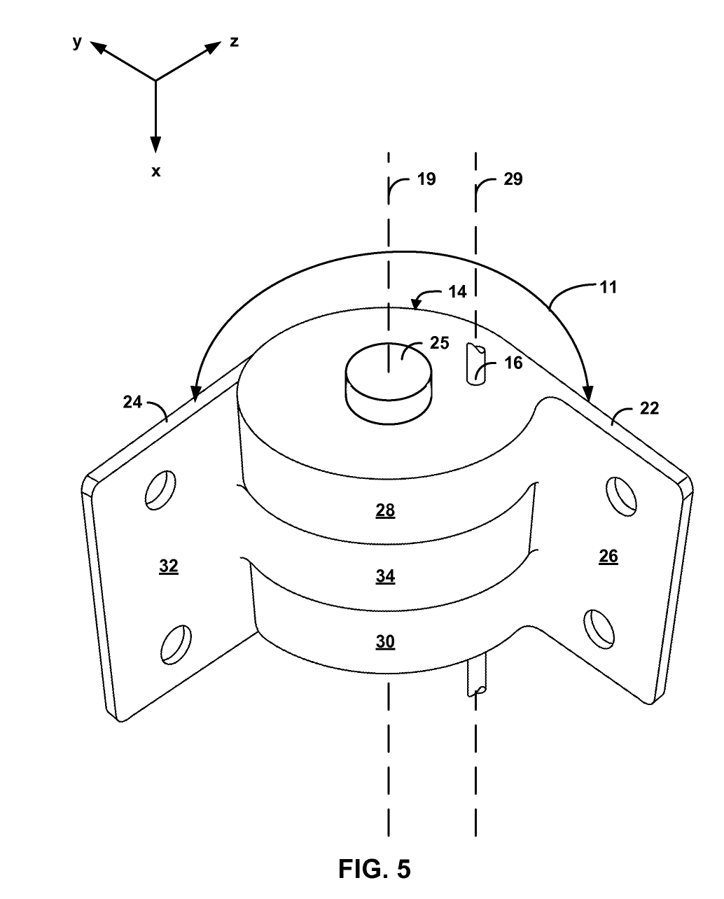

FIG. 5 illustrates a schematic perspective view of the example configuration of hinge 14 and cable 16 also shown in FIG. 4, in which a portion of cable 16 extends through hinge 14 along axis 29 that is not coaxial with axis of rotation 19, but may be substantially parallel to axis of rotation 19. FIG. 5 illustrates cable 16 passing through rotating portions 28, 30, and 34 along axis 29 that that runs in an x-axis direction (orthogonal x-y-z axes are shown for purposes of description only) substantially parallel to the axis of rotation of cable 16.

As described with respect to FIG. 4, cable 16 includes segments 40A, 40B, and 40C extending through rotating portions 28, 34, and 30, respectively. As illustrated in FIG. 5, cable 16 extends through hinge 14 in a substantially x-axis direction along axis 29, which is substantially parallel to axis of rotation 19, but not coaxial with axis of rotation 19. From the perspective of FIG. 5, a portion of cable 16 is illustrated extending into the top surface of hinge 14 (where the top surface refers the surface of hinge 14 with the smallest x-axis position) and another portion of cable 16 is illustrated extending out of the bottom surface (not shown) of hinge 14 (where the bottom surface refers to the surface of hinge 14 with the greatest x-axis position).

In FIG. 5, hinge 14 is shown in a configuration that represents a closed position of door 20 when wall 18A and door 20 are mechanically coupled to hinge 14 on an outer surface of wall 18A and door 20. As illustrated in FIG. 5, mounting surfaces 26 and 32 form an angle of approximately 270 degrees relative to one another, which can correspond to angle 11 (FIG. 1) of approximately 270 degrees between wall 18A and door 20. For example, as illustrated in FIG. 1, door 20 of assembly 10 is in a closed position when wall 18A and door 20 form an angle 11 of approximately 270 degrees with one another. In other examples, door 20 may be in a closed position when wall 18A and door 20 form a different angle 11 with one another, e.g., an angle 11 of approximately 180 degrees.

When component 24 of hinge 14 is mechanically coupled to door 20, opening and closing of door 20 results in rotation of rotating portion 34 of hinge 14, which also induces rotation of segment 40B within hinge 14 because segment 40B is substantially fixed to portion 34 such that as portion 34 rotates about the center axis of hinge 14, segment 40B also rotates. For example, when a force is applied to door 20 to open door 20, component 24 may rotate in a substantially clockwise direction around axis of rotation 19 (from the perspective of FIG. 5) from the position of hinge 14 shown in FIG. 5. Consequently, segment 40B within rotating portion 34 rotates clockwise out of alignment with segments 40A (within rotating portion 28) and 40C (within rotating portion 30) because segments 40A and 40C remain stationary within component 22, which is mechanically coupled to wall 18A. Rotation of segment 40B out of alignment with segments 40A and 40C can result in an interruption in transmission of the signal through cable 16. A processor of assembly 10 can detect the interruption and determine that a potential tamper event has occurred.

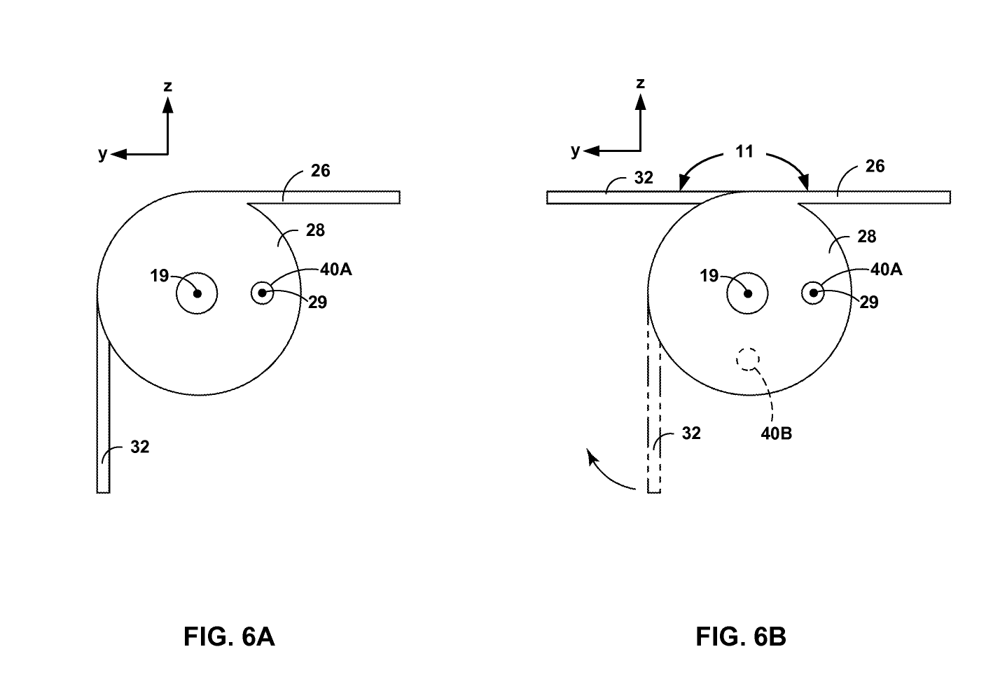

FIGS. 6A and 6B illustrate schematic cross-sectional top views of the example configuration of hinge 14 and cable 16 described with respect to FIGS. 4 and 5, in which a portion of cable 16 extends through hinge 14 along an axis separate from, but substantially parallel to, axis of rotation 19. The cross-section illustrated in FIGS. 6A and 6B is taken along line A-A shown in FIG. 4. FIG. 6A illustrates an example configuration of hinge 14 and cable 16 in which door 20 is closed, where door 20 forms an angle 11 (FIG. 1) of approximately 270 degrees with wall 18A to which door 20 is mechanically coupled. FIG. 6B illustrates an example configuration of hinge 14 and cable 16 in which door 20 is open, where door 20 forms an angle 11 of approximately 180 degrees with wall 18A.

FIG. 6A illustrates an example configuration of hinge 14 when door 20 is in a closed position. Segments 40A, 40B, and 40C of cable 16 are substantially aligned along an axis extending in a substantially x-axis direction. In the top view of FIGS. 6A and 6B, the top surface of rotating portion 28 of hinge 14 is shown, along with the top surfaces of mounting surfaces 26 and 32 extending outward from rotating portions 28, 30, and 34. FIG. 6A illustrates that segments 40A, 40B, and 40C of cable 16 are substantially aligned in the x-axis direction when door 20 is closed, creating a substantially direct and continuous pathway through which a signal can be transmitted. Because segments 40A, 40B, and 40C are substantially aligned in the x-axis direction, only the top segment 40A is visible in the top view of FIG. 6A. As discussed with respect to FIGS. 4 and 5, alignment of segments 40A, 40B, and 40C allows a signal to be transmitted through the direct and substantially continuous path defined by cable 16, which can signify that door 20 is closed and a potential tamper event has not occurred.

FIG. 6B illustrates an example configuration of hinge 14 and cable 16 when door 20 is in an open position, e.g., when a potential tamper event has occurred. In the example shown in FIG. 6B, angle 11 between door 20 and wall 18A is about 180 degrees. When door 20 is moved to an open position, rotating portion 34 (part of component 24) of hinge 14 rotates clockwise, from the perspective of FIGS. 6A and 6B, around axis of rotation 19 when component 24 is mechanically coupled to door 20. Mounting surface 32, another part of component 24, also rotates clockwise around axis of rotation 19. In FIG. 6B, hidden lines defining mounting surface 32 illustrate the top view of mounting surface 32 before rotation of hinge 14, and solid lines defining mounting surface 32 illustrate the top view of mounting surface 32 after rotation of hinge 14. As illustrated, mounting surface 32 extends in a substantially negative z-axis direction prior to rotation of hinge 14 (also shown in FIG. 6A) and in a substantially position y-axis direction after rotation of hinge 14.

As discussed with respect to FIGS. 4, 5, and 6A, segment 40B of cable 16 is positioned within rotating portion 34 of hinge 14, e.g., within an aperture defined by rotating portion 34, and is substantially fixed relative to rotating portion 34. Consequently, rotation of rotating portion 34 relative to rotating portions 28, 30 (FIG. 5) causes segment 40B to rotate and be displaced from segments 40A and 40C of cable 16 (positioned within rotating portions 28 and 30, respectively). In FIG. 6B, the position of segment 40B after rotation of hinge 14 (e.g., opening of door 20) is illustrated by hidden lines, which illustrates that segment 40B has rotated out of alignment with segments 40A, 40C. The connection between segments 40A, 40B, and 40C of cable 16 may be interrupted by the misalignment, resulting in an interruption in the signal transmitted by cable 16 through segments 40A-40C. A processor of assembly 10 can detect a potential tamper event based on the signal interruption.

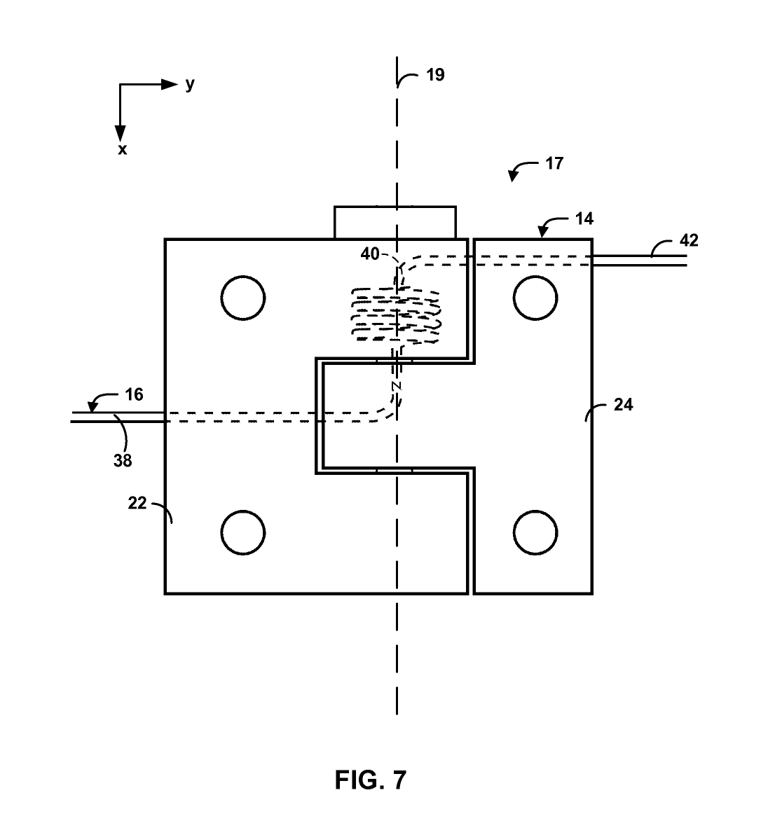

FIGS. 7-10 illustrate a third example configuration of tamper-indicating system 17 with cable 16 extending through hinge 14. In the example configuration illustrated in FIGS. 7-10, cable 16 extends through hinge 14 and is spooled within hinge 14 around axis of rotation 19. Rotation of hinge 14, e.g., caused by opening or closing of door 20, can cause cable 16 to wind or unwind within hinge 14 in the spooled configuration, which may help limit the strain exerted on cable 16 caused by stretching and unstretching of cable 16 within hinge 14.

In the example shown in FIG. 7, cable 16 may be anchored to wall 18A on a first side of hinge 14 and to door 20 on a second side of hinge 14. For example, segment 38 of cable 16 may be anchored (e.g., substantially fixed) to wall 18A, e.g., embedded within wall 18A, and segment 42 of cable 16 may be anchored (e.g., substantially fixed) to door 20, e.g., embedded within door 20. Segment 40 of cable 16 extends through hinge 14 and is wound in a spooled configuration within hinge 14 such that the center of the spool is coaxial with axis of rotation 19. (In FIG. 7, segment 40 of cable 16 is illustrated by hidden lines positioned within hinge 14.) In other examples, an axis of rotation of the spool may not be coaxial with axis of rotation 19 of hinge, but may instead be substantially parallel to axis of rotation 19 or have another configuration.

As illustrated in FIG. 7, segment 38 of cable 16 extends between mounting surface 26 of component 22 and wall 18A in a substantially y-axis direction and segment 42 of cable 16 extends between mounting surface 32 of component 24 and door 20 in a substantially y-axis direction. In some examples, mounting surfaces 26 and 32 may define conduits through which segments 38 and 42 of cable 16 can be threaded and extend into and out from hinge 14. In other examples, segments 38 and 42 of cable 16 may be positioned between and mechanically coupled to mounting surfaces 26 and 32 and wall 18A and door 20, respectively, in order for cable 16 to extend into and out from hinge 14 on both sides of hinge 14.

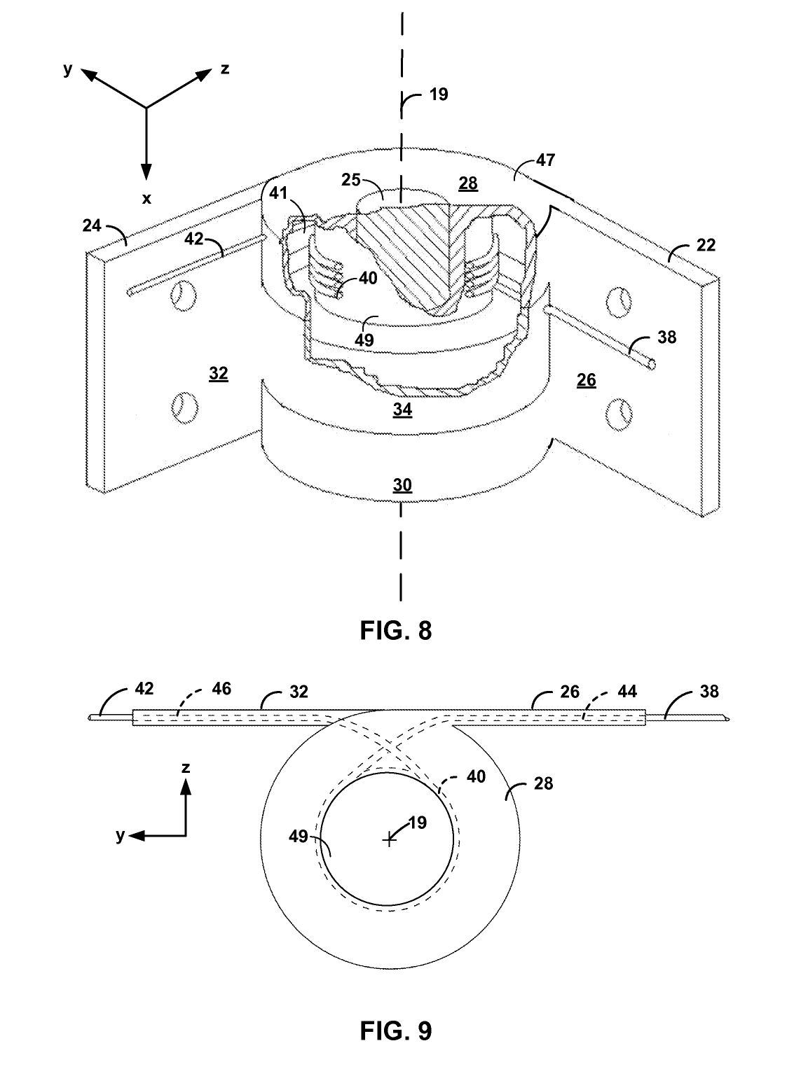

Within hinge 14, segment 40 of cable 16 is wrapped in a spool configuration such that the spool shares an axis of rotation with axis of rotation 19 of hinge 14. As illustrated in FIG. 8, in the example configuration illustrated in FIGS. 7-10, rotating portion 28 of hinge 14 defines a cavity into which segment 40 of cable 16 is positioned and wrapped in a spool configuration. Wrapping segment 40 of cable 16 in a spool configuration facilitates lengthening or shortening of segment 40 within hinge 14 to accommodate changes in length of the portion of cable 16 that extends through hinge 14 as a result of rotation of hinge 14 and movement of door 20 relative to wall 18A. For example, in some examples, the angle 11 (FIG. 1) between door 20 and wall 18A when door 20 is in a closed position may be greater than the angle 11 between door 20 and wall 18A when door 20 is in an open position. Rotation of hinge 14 may cause the distance over which segment 40 of cable 16 extends to increase or decrease. The spool mechanism can facilitate lengthening or shortening of segment 40 and prevent strain of segment 40, which may help prevent damage to cable 16. For example, cable 16 can wind and unwind around the axis of rotation of the spool to decrease or increase the distance over which segment 40 extends in response to rotation of hinge 14. That is, a force that increases the distance over which segment 40 extends, e.g., the force applied to close door 20 (or open door in examples in which hinge 14 is positioned in an interior of the container), may cause a portion of segment 40 wound around the spool to unwind from the spool in order to increase the length of segment 40. Similarly, a force that decreases the distance over which segment 40 extends, e.g., opening of door 20 (or closing of door 20 in examples in which hinge 14 is positioned in an interior of the container), may cause a portion of segment 40 to wind around the spool in order to decrease the length of segment 40.

In the example illustrated in FIGS. 7-10, cable 16 is wound directly around an inner portion of hinge 14 within rotating portion 28. In other examples, assembly 10 may include an additional spool component that is coupled to hinge 14, e.g., around the inner portion of hinge 14 within rotating portion 28, that is specifically configured to facilitate winding of cable 16 around the spool component. For example, the spool component may include ridges or grooves into which wound cable 16 can be positioned. This may allow cable 16 to be wound around the spool component in an organized manner. In some examples in which assembly 10 includes an additional spool component, the spool component may be spring loaded such that the spool 20 is biased to a position in which cable 16 is wound around the spool component in a spool configuration. This may help encourage cable 16 to wind around the spool component, e.g., as door 20 is opened.

With respect to FIGS. 8, 9, and 10, segment 40 of cable 16 is described as being wrapped around a spool. In some examples, this may signify that segment 40 itself can define the spool (e.g., segment 40 is wrapped in a spool configuration directly around a portion of hinge 14, as illustrated in FIG. 8). In other examples, this may signify that assembly 10 includes an additional spool component, e.g., as described above, and segment 40 may be wound around the spool component instead of being directly wound around a portion of the hinge.

FIG. 8 illustrates a schematic perspective view of the example configuration of hinge 14 and cable 16, in which a portion of cable 16 is wrapped around a spool within hinge 14 that has an axis of rotation that is substantially coaxial with axis of rotation 19. That is, in the illustrated example, cable 16 is wrapped in a spool configuration around an axis that is substantially coaxial with axis of rotation 19. Cable 16 includes segments 38, 40, and 42. In the example illustrated in FIG. 8, segment 40 extends through rotating portion 28 of hinge 14 and segments 38 and 42 extend from hinge 14 on either side of segment 40. Although not shown in FIG. 8, mounting surfaces 26 and 32 define respective conduits through which segments 38 and 42 of cable 16 extend. Segment 40 of cable 16 extends through hinge 14 and winds around a spool within hinge 14.

FIG. 8 includes a cutaway view of rotating portion 28 of hinge 14 in the example configuration illustrated in FIGS. 7-10. In this example configuration, rotating portion 28 includes outer shell 47 and inner portion 49. As illustrated in the cutaway section of FIG. 8, rotating portion 28 defines cavity 41 between outer shell 47 and inner portion 49 (e.g., rotating portion 28 is substantially hollow) within which segment 40 of cable 16 can be positioned. As illustrated, segment 40 of cable 16 is wound around inner portion 49 within rotating portion 28 in a spool configuration. Fastener 25 of assembly 10 may extend along axis of rotation 19 through inner portion 49 and, consequently, through spooled segment 40 of cable 16, as shown in FIG. 8.

As discussed above, the distance over which segment 40 of cable 16 extends can increase or decrease as a result of rotation of hinge 14, which can cause segment 40 to wind or unwind around inner portion 49. Winding and unwinding may cause the dimensions, e.g., the radius, of the spool configuration (including segment 40 of cable 16) to increase or decrease because the amount of slack in segment 40 of cable 16 may change, and cavity 41 can provide additional space to accommodate the changing dimensions of the spool. Cavity 41 can be sized and configured to accommodate any suitable type or configuration of cable 16.

In some examples, in addition to rotating portion 28, rotating portions 30 and 34 may also define respective cavities, e.g., may be substantially hollow. Consequently, in some examples, instead of extending only into rotating portion 28, segment 40 of cable 16 may be positioned within any one or more of rotating portions 28, 30, and 34 of hinge 14 and coiled around respective inner portions of the one or more rotating portions 28, 30, and 34.

In the example configuration illustrated in FIGS. 7-10, mounting surfaces 26 and 32 define respective conduits (not shown in FIG. 8) which extend into rotating portions 28 and 34 of hinge 14. The conduits may help route cable 16 into hinge 14 and into a spool configuration within rotating portion 28 (FIG. 9). For example, a conduit positioned within mounting surface 26 may help to route segment 38 of cable 16 into hinge 14 and a conduit positioned within mounting surface 32 may help to route segment 42 of cable 16 into hinge 14. In other examples, mounting surfaces 26 and 32 may not define any conduits.

FIG. 9 illustrates a schematic top view of the example tamper-indicating assembly illustrated in FIGS. 7 and 8. Hinge 14 is in an open configuration, e.g., a configuration in which door 20 of assembly 10 is open, in the example illustrated in FIG. 9. As shown in FIG. 9, mounting surface 26 of hinge 14 extends outward from rotating portions 28 and 30 in a substantially negative y-axis direction. Similarly, mounting surface 32 of hinge 14 extends outward from rotating portion 34 in a substantially y-axis direction.

As illustrated in FIG. 9, a conduit 44 is defined within mounting surface 26 and extends in a substantially y-axis direction through mounting surface 26 and into rotating portion 28 of hinge 14. Conduit 46 is defined within mounting surface 32 and extends in a substantially z-axis direction through mounting surface 32 and into rotating portion 34 of hinge 14. Other configurations of conduits 44, 46, e.g., extending in a different direction through hinge 14, are contemplated.

Although FIG. 9 illustrates conduits 44 and 46 extending into rotating portions 28 and 34, respectively, in other examples, conduits 44 and 46 may extend into different portions of hinge 14. For example, conduits 44 and 46 may extend into rotating portions 30 and 34, respectively. Alternatively, in some examples, mounting surfaces 26 and 32 may not define any conduits. For example, in some examples, segment 38 of cable 16 may be positioned between and mechanically coupled to mounting surface 26 and wall 18A, and segment 42 may be positioned between and mechanically coupled to mounting surface 32 and door 20.

As illustrated in FIG. 9, segment 38 of cable 16 extends through a conduit 44 defined by mounting surface 26 and into rotating portion 28 of hinge 14. Within rotating portions 28 and 34, segment 40 of cable 16 is wound around spool 48. Segment 42 of cable 16 exits rotating portion 34, and extends through conduit 46 within mounting surface 32. Mounting surfaces 26 and 32 can be mechanically coupled to wall 18A and door 20, respectively. In some examples, segments 38 and 42 move freely within conduits 44 and 46, respectively. That is, in some examples, segments 38 and 42 are not mechanically coupled to hinge 14 within conduits 44 and 46, and are substantially free to move within conduits 44 and 46.

In other examples, segments 38 and 42 are secured within conduits 44 and 46, respectively. For example, segments 38 and 42 may be mechanically coupled to hinge 14 within conduits 44 and 46. As one example, an adhesive may be applied between segments 38 and 42 and hinge 14 within conduits 44 and 46 to prevent movement of segments 38 and 42 within conduits 44 and 46.

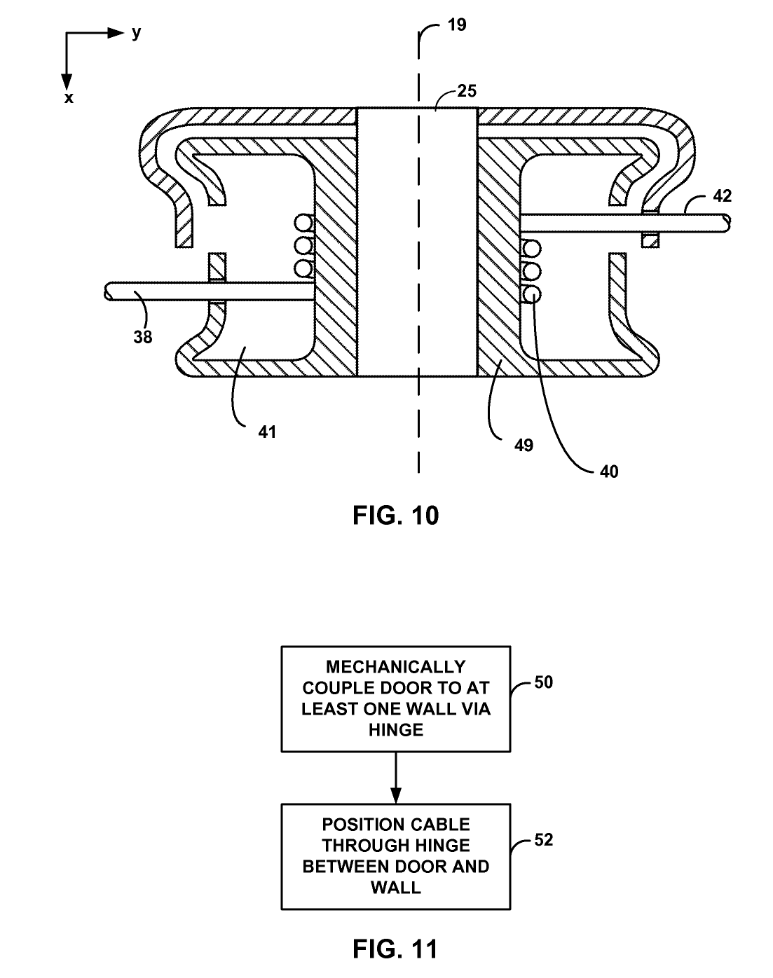

FIG. 10 illustrates a schematic cross-sectional view of a portion of hinge 14 from the example configuration also illustrated in FIGS. 7-9, taken within an x-y plane though a center of hinge 14. As illustrated in FIGS. 9 and 10, cable 16 is wound around inner portion 49 in a spool configuration within hinge 14. In particular, as illustrated, segments 38 and 42 of cable 16 extend into hinge 14 and segment 40 of cable 16 is wound in a spool configuration such that one end of segment 40, which is mechanically coupled to segment 38, extends toward component 26 of hinge 14 and the other end of segment 40, which is mechanically coupled to segment 42, extends toward component 32 of hinge 14.

Cable 16 winds around inner portion 49 in a spool configuration within hinge 14. In the example illustrated in FIGS. 7-10, fastener 25 (not shown in FIG. 9) extends through inner portion 49 of hinge 14 along axis of rotation 19. Segment 40 of cable 16 is wound around inner portion 49 and extends outward from inner portion 49 in the y-axis and z-axis directions into cavity 41 (FIG. 8) defined by outer shell 47 and inner portion 49 of rotating portion 28. As discussed with respect to FIGS. 7-9, upon rotation of hinge 14, the distance between wall 18A and door 20 over which segment 40 of cable 16 extends may change. For example, because segments 38 and 42 of cable 16 are anchored (e.g., substantially fixed) to wall 18A and door 20, respectively, the distance within hinge 14 over which segment 40 is positioned may change as the angle 11 (FIG. 1) between wall 18A and door 20 changes. Cavity 41 defines space within which segment 40 of cable 16 can lengthen and shorten as necessary in order to accommodate various angles 11 between wall 18A and door 20. In this way, the configuration of outer shell 47 and inner portion 49 may help accommodate mechanical flexing of cable 16 as it exits and enters hinge 14, which may help cable 16 move through hinge 14 without substantial pinching or binding.

The configuration of outer shell 47 and inner portion 49, e.g., to define cavity 41, can help prevent strain and stretching of cable 16 that could result in example configurations that do not include such a configuration. For example, cavity 41 provides a space in which segment 40 of cable 16 can lengthen and shorten based on rotation of hinge 14, in contrast to configurations in which cable 16 is stretched tightly within hinge 14 and may not accommodate the change in length of cable 16 that extends between door 20 and wall 18A as door 20 opens and closes.

Although FIGS. 7-10 include segment 40 wound around inner portion 49 of rotating portion 28, in other examples, segment 40 may be positioned differently. For example, in some examples, assembly 10 may define an aperture within which fastener 25 is positioned, and segment 40 may extend through hinge 14 into the aperture and wind around fastener 25 within the aperture. In these examples, the aperture may be defined such that there is sufficient space within the aperture to accommodate changes in configuration, e.g., radius, of spooled segment 40 that may result from rotation of hinge 14.

In some examples, a processor of assembly 10 can identify a potential tamper event based on movement of cable 16 over inner portion 49. For example, in some examples, the processor may determine that door 20 has been opened because segment 40 of cable 16 has shortened or lengthened by winding or unwinding around inner portion 49. The winding or unwinding of cable 16 may cause properties of the signal transmitted through cable 16 to change, and the processor may determine that a potential tamper event has occurred based on the changes in signal properties. In some examples, one or more components of assembly 10 may perform a defensive action in order to protect the articles stored within container 12.

Although not illustrated in FIGS. 7-10, in some examples, assembly 10 may include an addition spool component around which segment 40 is wound. That is, assembly 10 may include a component that is specifically configured to provide a mechanism around which segment 40 can wind, instead of a configuration in which segment 40 is directly wound around a portion of hinge 14, e.g., an inner portion 49. The spool component may be formed in any configuration suitable for providing a mechanism for lengthening and shortening segment 40 of cable 16. For example, in some examples, the spool component may include pre-defined grooves, flanges or threads such that segment 40 of cable 16 may coil and uncoil within the pre-defined grooves, flanges or threads. The predefined grooves, threads or flanges can act as tracks that help guide cable 16 to predefined positions around the spool component as cable 16 wraps around the spool component, which can help prevent tangling of segment 40 of cable 16 around the spool component. In other examples, the spool component may define a substantially smooth surface.

In addition, in some examples, the spool component may include a mechanism, such as a spring, that can bias cable 16 to return to a wound position around the spool component. That is, the spool component may, in some examples, be configured with a mechanism that applies a force to cable 16 which causes cable 16 to revert to a wound configuration around the spool component. For example, the spool component may be loaded with a spring that pulls cable 16 to wind around the spool component. The force from the spool component can pull cable 16 inward toward axis of rotation 19. A force created by anchoring segments 38 and 42 on either side of hinge 14 can counteract the force from the spool, which allows cable 16 to wind and unwind around the spool component substantially as much as necessary to correlate to opening and closing of door 20.

In some examples, the spool component may be positioned on an outer surface of inner portion 49 of rotating portion 28, e.g., between segment 40 and the outer surface of inner portion 49. For example, the spool component may be formed integrally with inner portion 49 such that the outer surface of the spool component is flush with the outer surface of inner portion 49. In other examples, the spool component may extend radially outward from the outer surface of inner portion 49.

In other examples, assembly 10 may be configured to define an aperture within inner portion 49 into which fastener 25 can be positioned, and the spool component may be formed integrally with fastener 25 within the aperture. For example, fastener 25 may be defined by an upper portion and a lower portion, and the spool component may be positioned between and mechanically coupled to the upper portion and the lower portion to form a single unit. In other examples, the spool component may be positioned around and mechanically coupled to the outer surface of fastener 25, e.g., as a sleeve. In other examples, the spool component may be defined by fastener 25, e.g., a portion of fastener 12 may be carved to include threads or flanges for winding of cable 16.

In the examples described herein, hinge 14 is mechanically coupled to the outer surface of container 12, e.g., as illustrated in FIG. 1. In these examples, the distance between door 20 and wall 18A may be greatest when door 20 is closed. That is, the angle 11 between the outer surfaces of top wall 18A and door 20 may be greatest when door 20 is closed and smallest when door 20 is open. As a result, cable 16 may traverse a longer distance when door 20 is closed. For example, the portion of cable 16 that extends at least partially through hinge 14 may be in its most stretched state when door 20 is closed and may become relatively unstretched when door 20 opens.

In other examples, hinge 14 may be mechanically coupled to an inner surface of container 12. In these examples, the distance between door 20 and wall 18A may be greatest when door 20 is open. That is, the angle between the inner surfaces of top wall 18A and door 20 may be smallest when door 20 is closed and greatest when door 20 is open. As a result, cable 16 may traverse a longer distance when door 20 is open. For example, the portion of cable 16 that extends at least partially through hinge 14 may be in its most stretched state when door 20 is open and may become relatively unstretched when door 20 closes. In other examples, hinge 14, wall 18A, and door 20 may have a different configuration. FIG. 11 is a flow diagram illustrating an example technique for forming an assembly, such as assembly 10, which includes one or more walls, a door coupled to at least one of the walls via one or more hinges, and a cable extending through the one or more hinges between the door and the wall. While FIG. 11 is described with respect to assembly 10, the technique illustrated in FIG. 11 can be used to form another assembly that can identify a potential tamper event using a tamper-indicating system that includes a cable extending at least partially through a hinge.

Container 12, including a plurality of walls 18, may be formed using any suitable technique. For example, in examples in which container 12 is formed from a metal material, walls 18 of container 12 may be mechanically coupled to one another via a technique, such as welding or soldering. As another example, in examples in which container 12 is formed from a plastic material, walls 18 of container 12 may be mechanically coupled to one another via a bonding agent, such as an adhesive, or via a welding technique (e.g., ultrasonic welding).

Door 20 is mechanically coupled to at least one of the walls 18 of container 12 via one or more hinges 14 (50). For example, in the example configurations illustrated in FIGS. 1-10, hinges 14 can be mechanically coupled to door 20 and wall 18A via one or more fasteners positioned through apertures defined within mounting surfaces 26 and 32 of hinges 14. Additionally or alternatively, hinges 14 can be mechanically coupled to door 20 and wall 18A via another mechanism, such as an adhesive. Hinges 14 are configured to permit door 20 to rotate open and closed relative to at least one of the walls 18.

Cable 16 is positioned such that cable 16 extends at least partially through one or more hinges 14 in order to detect movement of hinge 14, and, therefore, a potential tamper event (52). As an example, in some examples, cable 16 can be secured to wall 18A and door 20 on either side of hinge 14, and may extend through hinge 14 along axis of rotation 19, e.g., as in the example configuration illustrated in FIGS. 2 and 3. For example, cable 16 may be embedded or at least partially embedded within wall 18A and door 20 on either side of hinge 14, and cable 16 may be threaded through an aperture extending along axis of rotation 19. In some examples, cable 16 may be configured with a strain-relief mechanism in order to prevent damage to cable 16 caused by rotation of hinge 14. For example, cable 16 may be configured with a counter-twist that can be released upon opening and/or closing of door 20.

In some examples, assembly 10 includes one or more signal transmitters that transmit a signal through cable 16, and one or more sensors that sense the signal at another portion of cable 16. For example, the signal transmitter can introduce a signal at a first portion of cable 16 on a first side of a hinge 14 (e.g., at a first end of cable 16), and the one or more sensors can detect the signal at another portion of cable 16 on the other side of hinge 14 (e.g., at an opposing end of cable 16 from the signal transmitter). Assembly 10 can further include one or more processors that receive the sensed signal (e.g., the raw signal, one or more characteristics extracted from the raw signal or a parameterized signal), and determine whether the sensed signal indicates cable 16 has changed position within hinge 14, and, therefore, whether door 20 has been opened. Assembly 10 can be configured with one or more components that identify a potential tamper event based on the changes in signal properties and that may perform a defensive action, such as transmitting an alert, destroying assembly 10, destroying the one or more articles stored within container 12, disabling the one or more articles, and/or disabling the assembly 10, in response to determining that a potential tamper event has occurred.

As another example, in some examples, cable 16 may extend through hinge 14 along an axis separate from (e.g., not coaxial with), but substantially parallel to, axis of rotation 19, e.g., as in the example configuration illustrated in FIGS. 4, 5, 6A, and 6B. For example, hinge 14 may be formed to define apertures along an axis separate from, but parallel to, axis of rotation 19 into which cable 16 can be positioned. In some examples, the portion of cable 14 within hinge 14 may be defined by more than one distinct segments that are separate from each other and correspond to one or more apertures defined within different portions of hinge 14 that move relative to one another, e.g., rotating portions 28, 30, and 34. The segments can be positioned within the aperture within different portions of hinge 14 such that the different segments of cable 16 split apart and there is a discontinuity in cable 16 when hinge 14 rotates. The discontinuity may result in an interruption in the signal transmitted by cable 16, and the assembly 10 may be configured with one or more components that can determine that a potential tamper event has occurred based on the interruption in the signal. In some examples, assembly 10 is configured with one or more components that can perform a defensive action, such as transmitting an alert, destroying assembly 10, destroying the one or more articles stored within container 12, disabling the one or more articles, and/or disabling the assembly 10, in response to determining that a potential tamper event has occurred.

As another example, in some examples, cable 16 can be wound around a spool 48 (FIG. 10) within hinge 14 that is aligned with axis of rotation 19. For example, cable 16 can be wound around a spool 48 that can be positioned within and mechanically coupled to hinge 14 or a component of hinge 14. In the example illustrated in FIG. 10, hinge 14 includes a fastener 25 that mechanically coupled components of hinge 14 to one another, and spool 48 mechanically coupled to fastener 25. In some examples, the spool 48 can be formed with threads or flanges to accommodate cable 16 wound around the spool 48. Cable 16 can be mechanically coupled to wall 18A and door 20 on either side of hinge 14.

In some examples, hinge 14 is formed with one or more conduits into which portions of cable 16 can be threaded, e.g., conduits 44 and 46. Cable 16 can wind and unwind around spool 48 in order to prevent stretching of cable 16 resulting from rotation of hinge 14. Winding and unwinding of cable 16 around spool 48 can result in changes in the properties of the signal transmitted by cable 16, and assembly 10 can be configured to include a processor that detects rotation of hinges 14 events based on one or more characteristics of the sensed signal. Assembly 10 can be configured with one or more components that identify a potential tamper event based on the changes in signal properties and that may perform a defensive action, such as transmitting an alert, destroying assembly 10, destroying the one or more articles stored within container 12, disabling the one or more articles, and/or disabling the assembly 10, in response to determining that a potential tamper event has occurred.

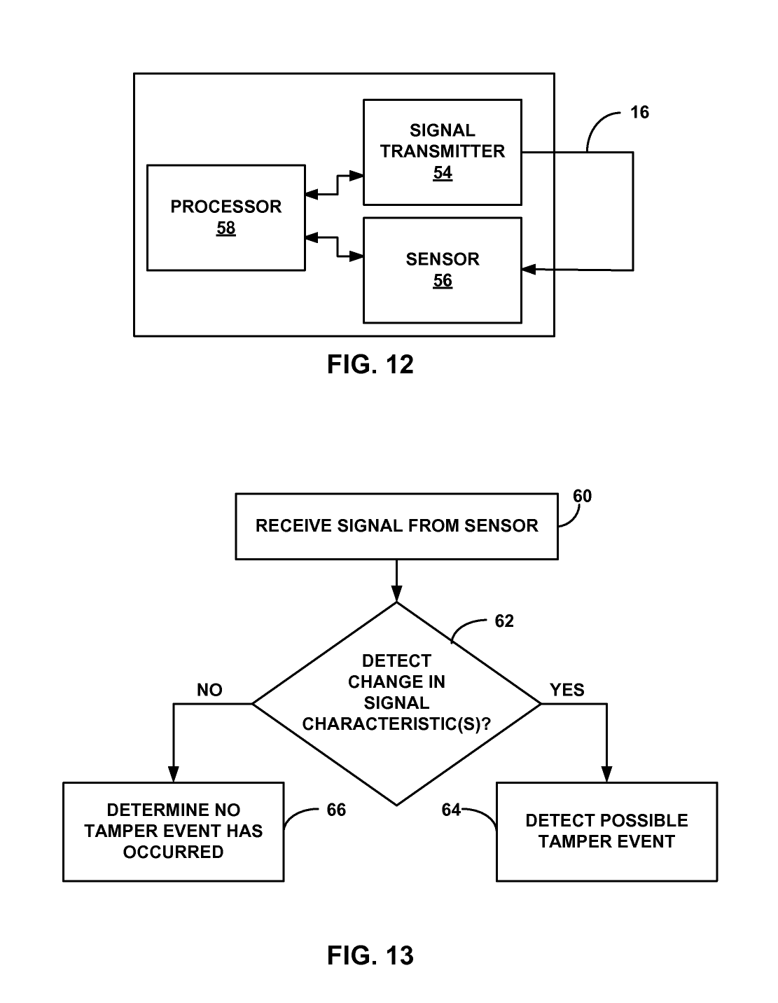

FIG. 12 is a functional block diagram illustrating components of assembly 10 that can detect a possible tamper event. In the example illustrated in FIG. 12, signal transmitter 54, sensor 56, and processor 58 operate together to detect possible tampering with container 12 based on a signal transmitted through cable 16. Signal transmitter 54, sensor 56, and processor 58 can have any suitable arrangement relative to container 12. In some examples, signal transmitter 54, sensor 56, and/or processor 58 are incorporated into one or more walls 18 and/or door 20 of container 12 (e.g., embedded in the wall 18 or door 20), while in other examples, signal transmitter 54, sensor 56, and/or processor 58 are mechanically coupled to an interior surface (e.g., facing the cavity defined by walls 28 and door 20) or mechanically coupled to an exterior surface of one or more walls 18 and/or door 20. In yet other examples, signal transmitter 54, sensor 56, and/or processor 58 may be separate from container 12. For example, processor 58 can be physically separate from container 12 and configured to communicate with signal transmitter 54 and/or sensor 56 via a wired or wireless connection using any of a variety of local wireless communication techniques, such as radio frequency (RF) communication according to the IEEE 802.11 or Bluetooth® specification sets, infrared (IR) communication according to the IRDA specification set, or other standard or proprietary telemetry protocols.

Signal transmitter 54 is configured to generate a signal that may be modulated by changes in the configuration (e.g., length, shape, and the like) of cable 16, or deformation of cable 16. In some examples, signal transmitter 54 is configured to generate an optical signal. As one example, signal transmitter 54 may include one or more photodiodes. In addition to or instead of an optical signal generator, signal transmitter 54 may be configured to generate an electrical signal. For example, signal transmitter 54 can include a power source and circuitry that is configured to generate an electrical signal having predetermined signal characteristics (e.g., frequency, amplitude, pulse width, and the like).

Signal transmitter 54 generates and transmits a signal, e.g., a light signal or an electrical signal, through cable 16. For example, signal transmitter 54 may be positioned at and/or coupled to a first end of cable 16 and may transmit the signal substantially entirely through cable 16, e.g., along substantially the entire length of cable 16. The signal transmitted by signal transmitter 54 traverses through cable 16, which extends at least partially through hinge 14, and the signal may be sensed by sensor 56. For example, in some examples, signal transmitter 54 may be positioned on or within a first portion of cable 16, e.g., a first end, and sensor 56 may be positioned on or within a second portion of cable 16, e.g., a second end. In this way, the signal may be transmitted between signal transmitter 54 and sensor 56.

Sensor 56 is configured to sense the signal generated by signal transmitter 54 and generate an electrical signal that is indicative of the signal sensed by sensor 56. For example, in examples in which signal transmitter 54 generates and delivers an optical signal through cable 16, sensor 56 can include a photodiode or the like, which generates an electrical signal that is modulated based an intensity of light incident on the sensor. In other examples, sensor 56 may include an optical continuity sensor that includes a first component that transmits light from a first component on cable 16 and a second component that receives and measures the light at a second position on cable 16. In examples in which signal transmitter 54 generates and delivers an electrical signal through cable 16, sensor 56 can include any suitable electrical sensor, such as a voltmeter (e.g., to measure voltage differentials) or an ohmmeter (e.g., to measure current).

Assembly 10 also includes processor 58, which receives the signal (e.g., an electrical or optical signal) generated and/or sensed by sensor 56 and determines, based on the signal, whether a possible tamper event has occurred. As discussed previously, because cable 16 extends at least partially through hinge 14, the signal transmitted through cable 16 may be modulated as a result of rotation of hinge 14, which can signify that door 20 has been opened and that a possible tamper event has occurred. Thus, for example, processor 58 may compare a characteristic of the sensed signal to a predetermined value (e.g., stored by a memory of assembly 10) in order to determine whether the properties of the signal transmitted through cable 16 indicate door 20 has been opened. If the characteristic of the signal from sensor 56 does not substantially match the predetermined value, processor 58 may determine that a possible tamper event has occurred, e.g., that door 20 has been opened. In some examples, the predetermined value may be an average value of the signal characteristic for a particular number, e.g., ten, of prior measurements.

Processor 58 may include any one or more microprocessors, controllers, digital signal processors (DSPs), application specific integrated circuits (ASICs), field-programmable gate arrays (FPGAs), and discrete logic circuitry. The functions attributed to the one or more processors described herein may be provided by a hardware device and embodied as software, firmware, hardware, or any combination thereof.

Upon identification of a possible tamper event, processor 58 can store an indication of the occurrence of the tamper event in a memory of assembly 10. In addition or instead, in some examples, processor 58 may initiate a defensive action to protect the one or more articles housed within container 12. In some examples, the processors may initiate a defensive action after a particular number of possible tamper events have occurred, e.g., after two or more possible tamper events.

FIG. 13 is a flow diagram illustrating an example technique for identifying a possible tamper event with assembly 10. While FIG. 13 is described as being performed by processor 58 of assembly 10, in other examples, a different processor can perform any part of the technique shown in FIG. 13.

Signal transmitter 54 transmits a signal through cable 16, which at least partially extends through hinge 14. The signal may be modulated based on rotation of hinge 14, such that at least one characteristic the signal may change as door 20 is opened or closed. Sensor 56 senses the signal (e.g., an optical signal or an electrical signal) and generates an electrical signal that exhibits at least one characteristic that changes as a function of the sensed signal. Processor 58 receives the electrical signal from sensor 56 (60). Processor 58 determines whether there has been a change in one or more predetermined characteristics of the electrical signal (62).

In examples in which signal transmitter 54 generates and transmits an electrical signal, the one or more predetermined characteristics of the electrical signal generated by sensor 56 may indicate the frequency, amplitude, pulse width or other characteristic of the electrical signal transmitted through cable 16 and sensed by sensor 56. In examples in which signal transmitter 54 generates and transmits an optical signal, the one or more predetermined characteristics of the electrical signal generated by sensor 56 may indicate a characteristic of the optical signal sensed by sensor 56. Example characteristics include, for example, phase, polarization, wavelength, brightness, and/or transit time of the light.

Processor 58 determines whether there has been a change in one or more predetermined characteristics of the electrical signal (62) using any suitable technique. In one example, processor 58 may compare the one or more predetermined characteristics of the signal from sensor 56 to a predetermined and stored value, which may indicate, for example, that door 20 has not been opened. The predetermined value can be determined when door 20 is closed, and, as a result, the predetermined value may be substantially correlated to a state in which door 20 is closed. If processor 58 determines that the one or more signal characteristics have not changed, e.g., substantially match the respective predetermined value, processor 58 may determine that there has not been a tamper event (66).

On the other hand, if processor 58 determines that the one or more signal characteristics have changed, e.g., do not match the respective predetermined values, processor 58 may detect a possible tamper event (64). For example, processor 58 may determine that door 20 is in an open state based on detecting a change in properties of the signal transmitted through cable 16. In some examples, processor 58 may initiate a defensive action, e.g., transmitting an alert, destroying assembly 10, destroying one or more articles stored within container 12, disabling one or more articles stored by container 12, and/or disabling the assembly 10, in response to detecting a possible tamper event. The alert can be a signal, auditory alert, visual alert or a somatosensory alert transmitted, for example, to a receiving device, which may be in the vicinity of container 12 or may be remotely located. In other examples, the alert can be an auditory alert, visual alert or a somatosensory alert that is generated at container 12 and audible, visible, or perceived by a person or device proximate container 12. The defensive action may be initiated within a relatively short time of determining that door 20 is in an open state, e.g., within a less than one second (e.g., within a few milliseconds) of determining that door 20 is in an open state. Other timelines for the defensive action relative to the opening of door 20 are contemplated, and can be greater or less than one second.

Processor 58 can perform the technique shown in FIG. 13 at any suitable frequency. For example, processor 58 can detect the change in the characteristic of the signal generated by sensor 56 at a frequency of about 1 hertz (Hz) to about 1 MHz. However, other frequencies are contemplated. The frequency should be selected to be high enough to detect a relatively quick opening and closing of door 20 because tampering may occur even though door 20 may only be open for a second or a fraction of a second.

The techniques described in this disclosure, including those attributed to processor 58, may be implemented, at least in part, in hardware, software, firmware or any combination thereof. For example, various aspects of the techniques may be implemented within one or more processors, including one or more microprocessors, DSPs, ASICs, FPGAs, or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. Such hardware, software, firmware may be implemented within the same device or within separate devices to support the various operations and functions described in this disclosure.

In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components, or integrated within common or separate hardware or software components.

When implemented in software, the functionality ascribed to the systems, devices and techniques described in this disclosure may be embodied as instructions on a computer-readable medium such as random access memory (RAM), read only memory (ROM), non-volatile RAM (NVRAM), electrically erasable programmable ROM (EEPROM), flash memory, magnetic data storage media, optical data storage media, or the like. The instructions may be executed to support one or more aspects of the functionality described in this disclosure. The computer-readable medium may be non-transitory.

Various examples have been described. These and other examples are within the scope of the following claims.

1. A tamper-indicating assembly comprising:
a plurality of walls;
a door, wherein the plurality of walls and the door define a cavity;
at least one hinge configured to mechanically couple the door to at least one wall of the plurality of walls; and
at least one cable extending at least partially through the hinge between the door and the at least one wall.

2. The assembly of claim 1, wherein the at least one cable comprises at least one of a fiber optic cable or an electrical cable.

3. The assembly of claim 1, further comprising a sensor and a processor, wherein the sensor generates a first signal indicative of a second signal transmitted through the cable and the processor detects rotation of the hinge based on the first signal.

4. The assembly of claim 3, wherein the processor detects rotation of the hinge by at least comparing at least one characteristic of the first signal to a predetermined value and determining that the measurement is substantially different than the predetermined value.

5. The assembly of claim 3, wherein the processor initiates at least one defensive action in response to detecting rotation of the hinge.

6. The assembly of claim 5, further comprising an article housed within the cavity, wherein the at least one defensive action comprises at least one of transmitting an alert, destroying the article, destroying the assembly, disabling the article, or disabling the assembly.

7. The assembly of claim 1, wherein the at least one cable is at least partially secured to the at least one wall and to the door.

8. The assembly of claim 1, wherein the hinge defines an aperture and wherein the at least one cable extends at least partially through the aperture.

9. The assembly of claim 1, wherein the hinge rotates about an axis of rotation and wherein the at least one cable extends at least partially through the hinge along the axis of rotation.

10. The assembly of claim 1, wherein the hinge rotates about an axis of rotation and wherein the at least one cable extends at least partially through the hinge along an axis that is separate from, but substantially parallel to, the axis of rotation.

11. The assembly of claim 1, wherein the at least one cable is at least partially wound in a spool configuration within the hinge.

12. The assembly of claim 1, wherein the hinge rotates and wherein at least one cable extending at least partially through the hinge is configured with a strain-relief mechanism to prevent substantial damage to the cable resulting from rotation of the hinge.

13. A method comprising:
mechanically coupling a door to at least one wall of a plurality of walls via at least one hinge, wherein the plurality of walls and the door define a cavity; and
positioning at least one cable such that the at least one cable extends at least partially through the hinge between the door and the at least one wall.

14. The method of claim 13, further comprising coupling a signal transmitter to a first portion of the at least one cable and a sensor to a second portion of the at least one cable, the first and second portion being on opposite sides of the at least one hinge.

15. The method of claim 13, wherein the hinge rotates about an axis of rotation and wherein positioning the at least one cable comprises positioning the at least one cable such that the at least one cable extends at least partially through the hinge along the axis of rotation of the hinge.

16. The method of claim 13, wherein the hinge rotates about an axis of rotation and wherein positioning the at least one cable comprises positioning the at least one cable such that the at least one cable extends at least partially through the hinge along an axis that is separate from, but substantially parallel to, the axis of rotation of the hinge.

17. The method of claim 13, wherein positioning the at least one cable comprises positioning the at least one cable such that the at least one cable is at least partially wound in a spool configuration within the hinge.

18. The method of claim 13, wherein the hinge is configured to rotate and wherein the method further comprises configuring the at least one cable with a strain-relief mechanism that accommodates a change in distance that the at least one cable traverses, wherein the change in distance results from rotation of the hinge.

19. A method comprising:
detecting a change in at least one characteristic of a signal transmitted through at least one cable; and
detecting a possible tamper event based on detecting the change in the at least one characteristic of the signal, wherein the at least one cable extends at least partially through a hinge and wherein the change in the at least one property of the signal corresponds to rotation of the hinge.

20. The method of claim 19, further comprising initiating at least one defensive action in response to detecting rotation of the hinge.
